(19) United States
(12) Patent Application Publication
(10) Pub. No.: US 2013/0172493 A1
(43) Pub. Date: Jul. 4, 2013

(54) PROCESS FOR MAKING DENDRITIC POLYOLEFINS FROM TELECHELIC POLYCYCLIC OLEFINS

(71) Applicants: Shuji Luo, Bridgewater, NJ (US); Andy Haishung Tsou, Allentown, PA (US)

(72) Inventors: Shuji Luo, Bridgewater, NJ (US); Andy Haishung Tsou, Allentown, PA (US)

(73) Assignee: EXXONMOBIL RESEARCH AND ENGINEERING COMPANY, Annandale, NJ (US)

(21) Appl. No.: 13/341,033

(22) Filed: Dec. 30, 2011

(51) Int. Cl. C08F 136/20; C08F 110/02

(52) U.S. Cl. 525/332.1; 525/333.7

(57) ABSTRACT

A process for making dendritic hydrocarbon polymers by reacting an amount of one or more telechelic hydrocarbon polymers with an amount of one or more multifunctional coupling agents under conditions sufficient to produce the dendritic hydrocarbon polymer. The telechelic hydrocarbon polymer is made by ring opening metathesis polymerization (ROMP) in the presence of bi-functional alkene chain terminating agents (CTAs). The dendritic hydrocarbon polymer can be hydrogenated to produce a substantially saturated dendritic hydrocarbon polymer. The dendritic polyethylenes (dPE) can be used as processability additives to provide extensional hardening in low concentrations in various conventional polyethylenes (PEs) such as HDPE, LLDPE and mLLDPE.

### FIELD

This disclosure relates to a process for making dendritic hydrocarbon polymers, in particular, the synthesis of dendritic polyolefins by chemical coupling of telechelic polycyclic olefins made by ring opening metathesis polymerization (ROMP) with trifunctional coupling agents.

### BACKGROUND

Polymers that have long branches (i.e., long enough to become entangled with other polymer strands) have qualitatively different flow behavior than those which are purely linear, and this profoundly affects the processing and crystallization of these polymers. It is often desirable to incorporate an amount of polymers having long-chain-branching (LCB) into polymers to achieve particular processability and properties. Dendritic polymers can be very useful in this regard, but their synthesis can be laborious and expensive.

While LCB technology has been a part of the polyethylene industry for some time, there is still a need to further optimize the type and availability of LCB polyethylenes and other polymers. A useful, inexpensive blend additive in the form of a LCB polymer could significantly impact the processing/performance balance for polyethylenes, particularly the multi-billion dollar market for polyethylene films and molded articles. There could be even greater use in polypropylene, where there is currently little commercially viable technology for incorporating LCB.

LDPE (Low Density Polyethylene) was introduced commercially in 1939 with excellent blown film processability but low stiffness and poor impact toughness. LDPE was made using peroxide initiated radical polymerization of ethylene and contains both short and long chain branches. Since there are no analytical methods available to fractionate LDPE by branch type, detailed long chain branch structures that are present in LDPE and the branch structure that is responsible for the excellent processability of LDPE are not known even at the present time. It has long been suspected that the dendritic PE structure may be in LDPE based on the kinetic simulation of LDPE reactors.

HDPE (High Density Polyethylene) was then introduced commercially in the 1950s synthesized via chromium oxide catalysts and is purely linear PE chains without any long and short chain branches. HDPE has excellent stiffness, but is poor in mechanical toughness and in blown film processability. LLDPE (Linear Low Density Polyethylene) was the next PE being commercialized in 1970's through the usage of Ziegler-Natta catalysts. LLDPE contains only short chain branches introduced through the addition of a linear alpha-olefin co-monomer during the coordinated Ziegler-Natta polymerization of ethylene. LLDPE has heterogeneous composition distribution but have good toughness, moderate stiffness, and poor blown film processability.

mLLDPE (metallocene Linear Low Density Polyethylene) was first introduced by ExxonMobil Chemical under the commercial name of Exceed in 1994. It is coordinated polymerized using metallocene catalysts and has homogeneous composition distribution containing only short chain branches. mLLDPE has excellent impact toughness, moderate stiffness, but very poor blown film processability. Enable mLLDPE, which is a new generation of mLLDPE introduced by ExxonMobil Chemical in 2008, has a better blown film processability than that of Exceed and contains a small amount of long chain branches that are of T-type, or star type.

One method to determine the blown film processability of PE resins is through the measurement of extension hardening using an extensional rheometer (Polym. Eng. Sci., 38 (1998), 1685-1693). LDPE can be extensionally hardened, whereas HDPE, LLDPE, and mLLDPE (including both Enable and Exceed) do not extensionally harden, except in few Enable grades that show weak strain hardening. Presently, in order to maximize the blown film line speed for better film quality and for cost reduction, it is a common practice to add 10% or more of LDPE in LLDPE or mLLDPE for extensional hardening and for better blown film processability (J. Appl. Polym. Sci., 88(2003), 3070-3077). However, the addition of LDPE in LLDPE or in mLLDPE compromises the impact toughness and mechanical stiffness of LLDPE and mLLDPE significantly.

It would be desirable to have processability additives such as dendritic polyethylenes (dPEs) to provide extensional hardening at low concentrations in various conventional polyethylenes (PEs) such as HDPE, LLDPE, and mLLDPE, without compromising other properties such as impact toughness and mechanical stiffness.

The present disclosure also provides many additional advantages, which shall become apparent as described below.

### SUMMARY

This disclosure relates in part to a process for making a dendritic hydrocarbon polymer. The process involves reacting an amount of one or more telechelic hydrocarbon polymers with an amount of one or more multifunctional coupling agents under conditions sufficient to produce the dendritic hydrocarbon polymer.

This disclosure also relates in part to a dendritic hydrocarbon polymer produced by the above process.

This disclosure further relates in part to a process for making a dendritic hydrocarbon polymer. The process involves polymerizing, by ring opening metathesis polymerization, an amount of one or more cyclic olefins with an amount of one or more bi-functional alkene chain terminating agents (CTAs) in the presence of a metathesis catalyst and under conditions sufficient to produce one or more telechelic hydrocarbon polymers. The one or more telechelic hydrocarbon polymers are then reacted with an amount of one or more multifunctional coupling agents under conditions sufficient to produce the dendritic hydrocarbon polymer.

This disclosure yet further relates in part to a dendritic hydrocarbon polymer produced by the above process.

This disclosure also relates in part to a process for making a substantially saturated dendritic hydrocarbon polymer. The process involves reacting an amount of one or more telechelic hydrocarbon polymers with an amount of one or more multifunctional coupling agents under conditions sufficient to produce a dendritic hydrocarbon polymer. The dendritic hydrocarbon polymer is then hydrogenated to produce the substantially saturated dendritic hydrocarbon polymer.

This disclosure further relates in part to a substantially saturated dendritic hydrocarbon polymer made by the above process.

This disclosure yet further relates in part to a process for making a substantially saturated dendritic hydrocarbon polymer. The process involves polymerizing, by ring opening metathesis polymerization, an amount of one or more cyclic olefins with an amount of one or more bi-functional alkene chain terminating agents (CTAs) in the presence of a metathesis catalyst and under conditions sufficient to produce one or more telechelic hydrocarbon polymers. The one or more telechelic hydrocarbon polymers are then reacted with an amount of one or more multifunctional coupling agents under conditions sufficient to produce a dendritic hydrocarbon polymer. The dendritic hydrocarbon polymer is then hydrogenated to produce the substantially saturated dendritic hydrocarbon polymer.

This disclosure also relates in part to a substantially saturated dendritic hydrocarbon polymer produced by the above process.

This disclosure further relates in part to a process for making a substantially saturated dendritic hydrocarbon polymer. The process involves hydrogenating one or more telechelic hydrocarbon polymers to produce substantially saturated one or more telechelic hydrocarbon polymers. The substantially saturated one or more telechelic hydrocarbon polymers are then reacted with an amount of one or more multifunctional coupling agents under conditions sufficient to produce the substantially saturated dendritic hydrocarbon polymer.

This disclosure yet further relates in part to a substantially saturated dendritic hydrocarbon polymer produced by the above process.

This disclosure also relates in part to a process for making a substantially saturated dendritic hydrocarbon polymer. The process involves polymerizing, by ring opening metathesis polymerization, an amount of one or more cyclic olefins with an amount of one or more bi-functional alkene chain terminating agents in the presence of a metathesis catalyst and under conditions sufficient to produce one or more telechelic hydrocarbon polymers. The one or more telechelic hydrocarbon polymers are then hydrogenated to produce substantially saturated one or more telechelic hydrocarbon polymers. The substantially saturated one or more telechelic hydrocarbon polymers are then reacted with an amount of one or more multifunctional coupling agents under conditions sufficient to produce the substantially saturated dendritic hydrocarbon polymer.

This disclosure further relates in part to a substantially saturated dendritic hydrocarbon polymer produced by the above process.

Several advantages result from the dendritic polyolefins and processes of this disclosure. This disclosure includes dendritic polyethylenes (dPEs) that can be used as processability additives to provide extensional hardening at 5 weight % or lower concentration in various conventional polyethylenes (PEs), such as HDPE, LLDPE, and mLLDPE. Without dPE additives currently used in the art in high concentrations, these conventional PEs do not harden upon extension. Extensional hardening is critical for blown film bubble stability and is the necessary condition for high blown film line speed, which currently achievable only by LDPE (Low Density Polyethylene). LDPE is a PE grade known to extensional-harden without processability additives.

Further objects, features and advantages of the present disclosure will be understood by reference to the following drawings and detailed description.

### BRIEF DESCRIPTION OF THE DRAWINGS

FIG. 1 depicts a representative dendritic polyethylene (dPE) and its synthesis.

FIG. 2 depicts ¹H NMR spectra of the telechelic hydrocarbon polymer (HO-PCOD) of Example 1 (CDCl₃, 27° C.).

FIG. 3 depicts ¹H NMR spectra of the dendritic hydrocarbon polymer (dPCOD1) of Example 2 (CDCl₃, 27° C.).

FIG. 4 depicts GPC-3D (gel permeation chromatography-three detectors) of the telechelic hydrocarbon polymer (HO-PCOD) and the dendritic hydrocarbon polymer (dPCOD1) of Examples 1 and 2 (THF, r.t.).

FIG. 5 depicts ¹H NMR spectra of the dendritic hydrocarbon polymer (dPCOD2) of Example 3 (CDCl₃, 27° C.).

FIG. 6 depicts GPC of the telechelic hydrocarbon polymer (HO-PCOD) and the dendritic hydrocarbon polymer (dPCOD2) of Examples 1 and 3 (THF, r.t.).

FIG. 7 depicts ¹H NMR spectra of the hydrogenated telechelic hydrocarbon polymer (HO-PE) of Example 5 (CDCl₂CDCl₂, or TCE, 115° C.).

FIG. 8 depicts ¹H NMR spectra of the dendritic hydrocarbon polymer (dPE3) of Example 9 (TCE, 115° C.).

FIG. 9 depicts GPC-3D of the dendritic hydrocarbon polymer (dPE3) of Example 9 (TCB, 135° C.).

FIG. 10 depicts ¹H NMR spectra of the dendritic hydrocarbon polymer (dPE4) of Example 10 (TCE, 115° C.).

FIG. 11 depicts GPC-3D of the dendritic hydrocarbon polymer (dPE4) of Example 10 (TCB, 135° C.).

FIG. 12 depicts ¹H NMR spectra of the dendritic hydrocarbon polymer (dPE5) of Example 11 (TCE, 115° C.).

FIG. 13 depicts GPC-3D of the dendritic hydrocarbon polymer (dPE5) of Example 11 (TCB, 135° C.).

FIG. 14 depicts ¹H NMR spectra of the dendritic hydrocarbon polymer (dPE6) of Example 12 (TCE, 110° C.).

FIG. 15 depicts SER (Sentmanat Extension Rheometer) of 1% and 3% dPE3 of Example 9 in Exceed 2018 (150° C.).

### DETAILED DESCRIPTION

All numerical values within the detailed description and the claims herein are modified by “about” or “approximately” the indicated value, and take into account experimental error and variations that would be expected by a person having ordinary skill in the art.

The process of the present disclosure for making dendritic polymers affords a high degree of control with respect to polymer architecture. The dendritic polymers are useful as rheology-enhancing blend additives in polymer materials or compositions. In particular, this disclosure describes the synthesis of dendritic polyethylene by coupling of telechelic polycyclic olefins made by ring opening metathesis polymerization (ROMP). The present disclosure provides for the preparation of well-defined dPEs with strictly linear and telechelic linker.

The process of this disclosure involves the synthesis of a dendritic hydrocarbon polymer, e.g., a dendritic polyolefin, by reacting an amount of one or more telechelic hydrocarbon polymers with an amount of one or more multifunctional coupling agents, e.g., trifunctional or tetrafunctional coupling agents or coupling agents with functionalities equal to or greater than 3, under conditions sufficient to produce the dendritic hydrocarbon polymer. A separate hydrogenation step is necessary to deliver substantially saturated polyolefins.

In particular, the process of this disclosure involves the synthesis of a dendritic hydrocarbon polymer, e.g., a dendritic polyolefin, by polymerizing, i.e., ring opening metathesis polymerization, an amount of one or more cyclic olefins and an amount of one or more bi-functional alkenes chain terminating agents (CTAs) in the presence of a metathesis catalyst to produce one or more telechelic hydrocarbon polymers. The one or more telechelic hydrocarbon polymers are then reacted with an amount of one or more multifunctional coupling agents, e.g., trifunctional silane, triols, tricarboxylic acid, tricarbonyl chloride coupling agents or tetrafunctional coupling agents, under conditions sufficient to produce the dendritic hydrocarbon polymer. A separate hydrogenation step is necessary to deliver substantially saturated polyolefins.

The cyclic olefins useful in the processes of this disclosure can be any cyclic olefins that are capable of ring opening and polymerization with a bi-functional alkene chain terminating agent. Illustrative cyclic olefins include, for example, cyclooctene, 1,5-cyclooctadiene, 1,5-dimethylcyclooctadiene, norbornene, cyclopentene, and 1,5,9-cyclododecatriene. Cyclic olefins with sufficient ring strains for ring opening metathesis polymerization are preferred. The method of this disclosure allows the selection of cyclic olefin monomers for designing the telechelic polyolefin backbone composition. The cyclic olefins are conventional materials known in the art and commercially available.

The bi-functional alkenes useful in the processes of this disclosure can be any bi-functional alkenes that are capable of terminating the metathesis ring opening polymerization with a cyclic olefin. Illustrative bi-functional alkenes include, for example, 1,4-diacetoxy-2-butene, 1,4-dibromo-2-butene, 1,4-dichloro-2-butene, maleic acid, and 9-octadecene-1,18-diol.

The concentration of the one or more propagating cyclic olefins and one or more terminating bi-functional alkenes used in the process of this disclosure can vary over a wide range and need only be concentrations sufficient to form the telechelic hydrocarbon polymer. The one or more cyclic olefins and one or more bi-functional alkenes can be present in a molar concentration ratio (cyclic olefin/bi-functional alkene) of from 5 to 2500, preferably from 10 to 500, and more preferably from 15 to 100.

The metathesis catalyst can be any catalyst suitable for catalyzing the metathesis polymerization. An illustrative metathesis catalysts useful in the process of this disclosure is a Grubbs 2^{nd} generation catalyst. The catalysts are conventional materials known in the art and commercially available.

The concentration of the metathesis catalyst used in the process of this disclosure can vary over a wide range and need only be a concentration sufficient to catalyze the polymerization. The metathesis catalyst can be present in an amount of from 0.001% to 1%, preferably from 0.01% to 0.5%, and more preferably from 0.01% to 0.2%.

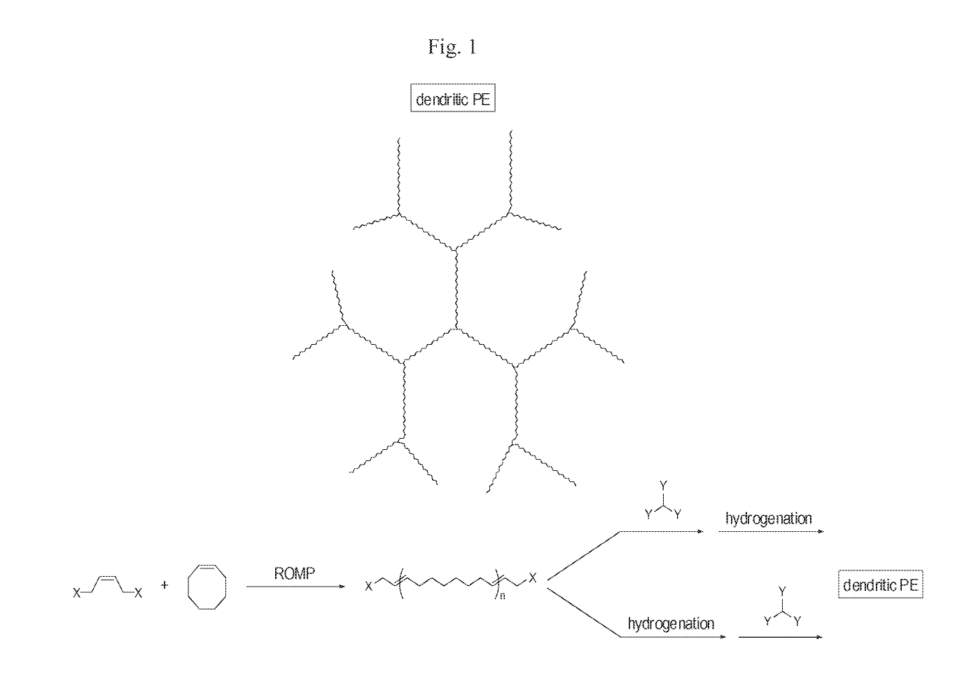

As shown in FIG. 1, other reactions subsequent to ROMP with CTA, e.g., hydrolysis, may also be employed to convert the telechelic chain ends to the desirable functional groups, e.g. from ester to hydroxyl. Such reactions may be carried out by conventional methods known in the art.

The telechelic hydrocarbon polymers useful in the processes of this disclosure can be any telechelic hydrocarbon polymers that are capable of reacting with a multifunctional coupling agent, e.g., trifunctional or a tetrafunctional coupling agents or coupling agents with functionalities equal to or greater than 3, to produce the dendritic hydrocarbon polymer. Illustrative telechelic hydrocarbon polymers include, for example, telechelic hydroxyl terminated poly(1,5-cyclooctadiene) (HO-PCOD), telechelic bromo terminated polycyclooctene (Br-PCOE), telechelic carboxy terminated polycyclooctene (HOOC-PCOE), and telechelic hydroxyl terminated polyethylene (HO-PE). The method of this disclosure allows the selection of telechelic hydrocarbon polymers for designing the dendritic polyolefin backbone composition. The telechelic hydrocarbon polymers are conventional materials known in the art.

The telechelic polycyclic olefins advantageously have molecular weight higher than three times of the polyethylene chain entanglement length (so to have an impact on polyethylene flow characteristics), i.e., 3000 g/mol, and lower than 500,000 g/mol. The molecular weight distribution is advantageously less than 5, more advantageously less than 4, and most advantageously less than 3.

The one or more multifunctional coupling agents useful in the processes of this disclosure can be any trifunctional or tetrafunctional coupling agents, or coupling agents with functionalities equal to or greater than 3, that are capable of reacting with a telechelic hydrocarbon polymer. Illustrative trifunctional coupling agents include, for example, trifunctional silanes, such as trichloromethylsilane, trichloroethoxysilane, 1-dichloromethyl-2-chlorodimethyl-disiloxane, 1-dichloromethylsilyl-2-chlorodimethylsilyl ethane, or triols, such as glycerol, 1,3,5-benzenetriol, 1,2,6-hexanetriol, 1,1,1-tris(hydroxymethyl)propane, or tricarboxylic acids and tricarbonyl chlorides, such as 1,2,4-benzenecarboxylic anhydride, 1,2,4-benzenecarboxylic acid, 1,3,5-benzenetricarboxylic acid, and trimesoyl chloride. Among the trifunctional silane coupling agents, preferred ones are selected from within the structure X₃Si(CH₂)ₙH or X₂(CH₃)₂Si—(CH₂)ₙ—Si(CH₃)₂X, wherein n is greater than or equal to 0 and X is a halogen or an alkoxy, and Cl(CH₃)₂Si—(CH₂)ₙ—SiCl(CH₃)—(CH₂)ₙ—SiCl(CH₃)₂, wherein n is greater than or equal to 0. Useful trifunctional coupling agents are disclosed, for example, in U.S. Pat. No. 5,360,875 and U.S. Patent Publication No. 2011/0118420, the disclosures of which are incorporated herein by reference in their entirety.

Illustrative tetrafunctional coupling agents include, for example, tetraols, such as pentaerythritol, or tetracarboxylic acids, such as benzophenone-3,3′,4,4′-tetracarboxylic dianhydride. Useful tetrafunctional coupling agents are disclosed, for example, in JP Patent No. 2004256646, the disclosure of which is incorporated herein by reference in its entirety.

The coupler can typically have three or more functionalities that can undergo condensation or click chemistry with the end group of telechelic polycyclic olefins. The three or more functionalities are needed to assemble the telechelic polycyclic olefins into dendritic structures as shown in FIG. 1. Preferably, the coupler is a molecule with three or four-functionalities. The assembly reaction can be carried out in tetrahydrofuran, chlorinated solvents or hydrocarbon solvents.

The concentration of the one or more telechelic hydrocarbon polymers and one or more multifunctional coupling agents used in the process of this disclosure can vary over a wide range and need only be concentrations sufficient to form the dendritic hydrocarbon polymer. The one or more telechelic hydrocarbon polymers and one or more multifunctional coupling agents can be present in an equivalent concentration ratio (telechelic hydrocarbon polymer/trifunctional coupling agent) of from 1.7 to 3.0 equivalents, preferably from 2.01 to 2.5 equivalents, and more preferably from 2.02 to 2.3 equivalents.

In order to minimize gelation, or crosslinking of the telechelic polycyclic olefins, the coupler can be diluted and added slowly to the solution of telechelic polycyclic olefins and needs to be kept below 0.6 when a trifunctional coupling agent is used to prevent gelation. The dPE thus obtained has a wide distribution of generation numbers, the average of which is determined by the stoichiometry of the telechelic polycyclic olefin and the coupler. For example, 2.1 equivalents of hydroxyl-terminated polycyclooctene and 1 equivalent of methyltrichlorosilane can give primarily 3^{rd} generation dendrimer, and 2.25 equivalents of hydroxyl-terminated polycyclooctene and 1 equivalent of methyltrichlorosilane can give primarily 2^{nd} generation dendrimer.

In one embodiment, the dendritic structure is a dendritic structure of at least generation 2. In another embodiment, the dendritic structure is a dendritic structure of at least generation 3.

The dendritic polyolefins prepared by the process of this disclosure preferably have a dendritic generation of 2 and higher and have molecular weight between 5,000 to 5,000,000, and most preferably between 10,000 and 1,000,000. Illustrative dendritic polyolefins prepared by the process of this disclosure include, for example, the following:

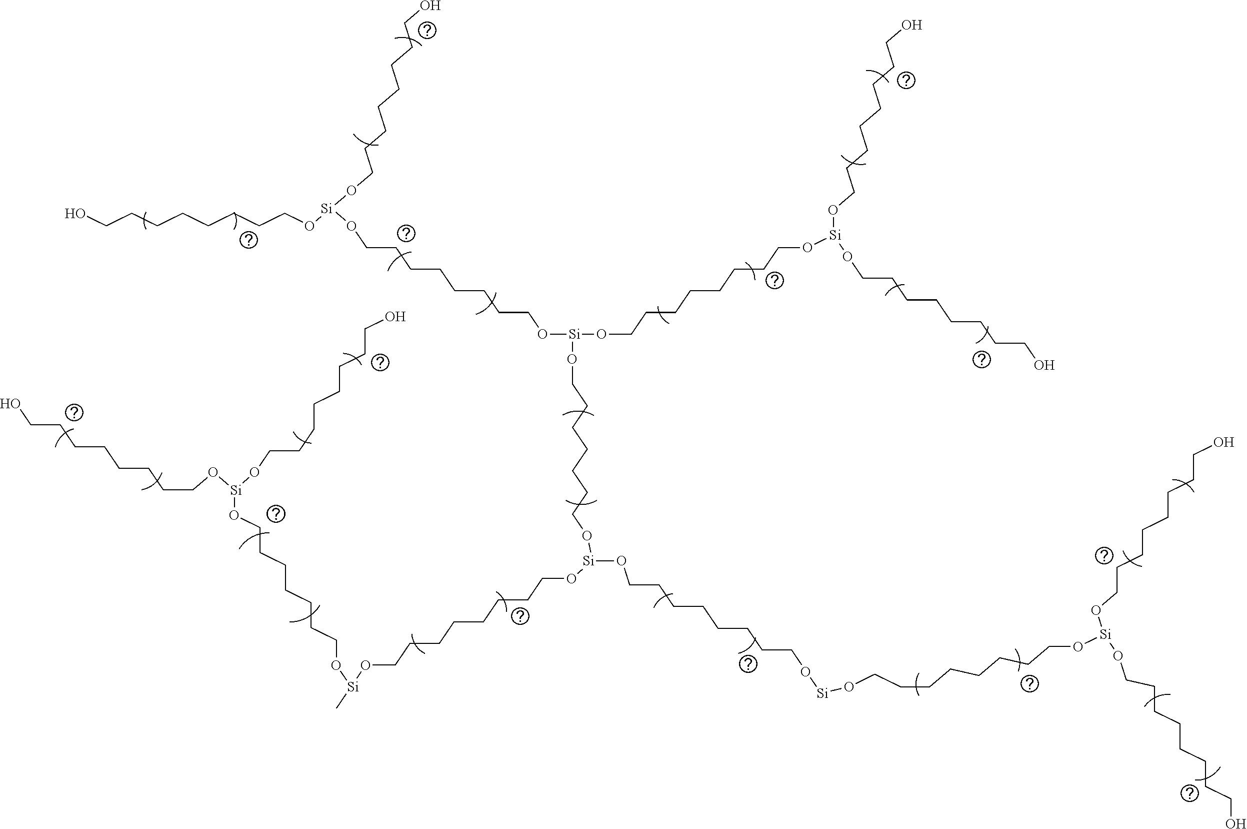

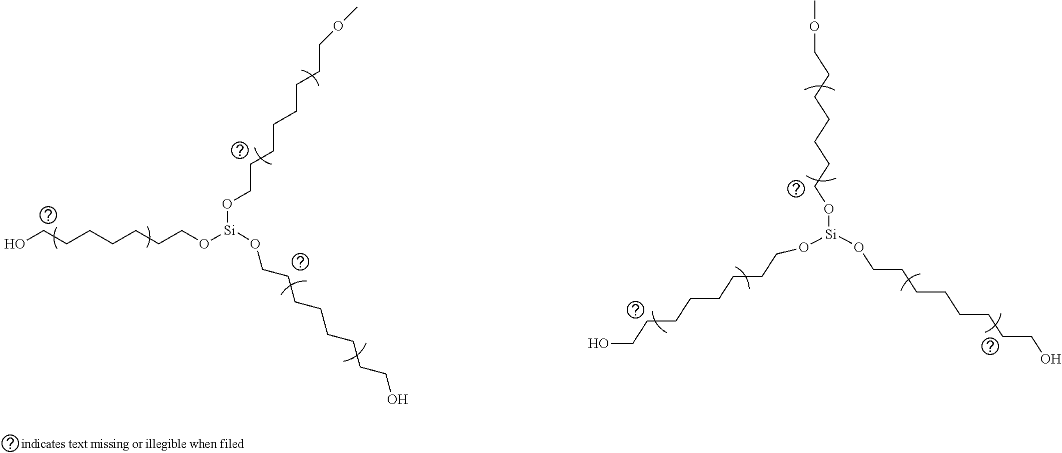

wherein n is a value greater than 50, preferably from 50 to 10,000, and most preferably from 50 to 2,000. The value of n in the above formula can be the same or different.

The crystalline dendritic polyolefins of this disclosure can be used as a processability additive in a semi-crystalline polyolefin of similar backbone composition for delivering extensional strain hardening, higher melt strength, and faster blown film processing speed at a concentration of 0.1 to 20 wt %, more preferably 0.25 to 15 wt %, and most preferably 0.5 to 10 wt %. The amorphous dendritic polyolefins of this disclosure can be used as a processability additive in an elastomeric polyolefin of similar backbone composition for delivering extensional hardening and higher melt strength for better compounding processability and cold flow resistance at a concentration of 0.1 to 20 wt %, more preferably 0.25 to 15 wt %, and most preferably 0.5 to 10 wt %. This amorphous dendritic polyolefin can also be used as a viscosity index improver in lubricants due to its temperature invariant solution coil dimension and its shear stability at a concentration of 0.01 to 7.5 wt %, more preferably 0.1 to 5 wt %, and most preferably 0.2 to 3 wt %.

Preferably, the dendritic polyethylenes (dPEs) of this disclosure can be used as processability additives to provide extensional hardening at 5 wt % or lower concentration in various conventional polyethylenes (PEs), such as HDPE, LLDPE, and mLLDPE.

The one or more cyclic olefins are ring opening metathesis polymerized in the presence of one or more bi-functional alkene chain terminating agents under conditions to produce the telechelic hydrocarbon polymer of sufficient molecular weight. Following the polymerization, the process can include other reactions such as hydrolysis to convert the chain end functionalities of the telechelic hydrocarbon polymers to those useful in the processes of this disclosure. The other reactions such as hydrolysis can be carried out by conventional procedures known in the art.

Metathesis polymerization conditions for the reaction of the one or more cyclic olefins with one or more bi-functional alkene CTAs, such as temperature, pressure and contact time, may also vary greatly and any suitable combination of such conditions may be employed herein. The reaction temperature may range between 20° C. to 120° C., and preferably between 30° C. to 100° C., and more preferably between 40° C. to 80° C. Normally the reaction is carried out under ambient pressure and the contact time may vary from a matter of seconds or minutes to a few hours or greater. The reactants can be added to the reaction mixture or combined in any order. The stir time employed can range from 2 min to 24 hours, preferably from 30 min to 12 hours, and more preferably from 1 to 8 hours.

The one or more telechelic hydrocarbon polymers are reacted with an amount of one or more multifunctional coupling agents, e.g., trifunctional or tetrafunctional coupling agents or coupling agents with functionalities equal to or greater than 3, under conditions sufficient to produce the dendritic hydrocarbon polymer. The coupling reaction is a condensation or click reaction and can be conducted by conventional procedures known in the art.

Coupling reaction conditions for the reaction of the one or more telechelic hydrocarbon polymers and one or more multifunctional coupling agents, such as temperature, pressure and contact time, may also vary greatly and any suitable combination of such conditions may be employed herein. The reaction temperature may range between 20° C. to 150° C., and preferably between 40° C. to 140° C., and more preferably between 50° C. to 130° C. Normally the reaction is carried out under ambient pressure and the contact time may vary from a matter of seconds or minutes to a few hours or greater. The reactants can be added to the reaction mixture or combined in any order. The stir time employed can range from 30 min to 72 hours, preferably from 1 to 24 hours, and more preferably from 1.5 to 16 hours.

In this synthetic method, reactions are performed under ambient pressure with a slight heating and are tolerant to ambient environment and impurities. All monomers and solvents can be used as received without purification.

Hydrogenation can be carried out in the process of the present disclosure by any known catalysis system, including heterogeneous systems and soluble systems. Soluble systems are disclosed in U.S. Pat. No. 4,284,835 at column 1, line 65 through column 9, line 16 as well as U.S. Pat. No. 4,980,331 at column 3 line 40 through column 6, line 28.

For purposes of the present disclosure, “substantially saturated” as it refers to the dendritic hydrocarbon polymer means that polymer includes on average fewer than 5 double bonds, or fewer than 3 double bonds, or fewer than 1 double bonds, or fewer than 0.5 double bond per one hundred carbon in the hydrocarbon polymer chain.

Additional teachings to hydrogenation are disclosed in Rachapudy et al., Journal of Polymer Science: Polymer Physics Edition, Vol. 17, 1211-1222 (1979), which is incorporated herein by reference in its entirety. Table 1 of the article discloses several systems including palladium on various supports (calcium carbonate, but also barium sulfide). The Rachapudy et al. article discloses preparation of homogeneous catalysts and heterogeneous catalysts.

The Rachapudy et al. article discloses a method of preparation of a homogeneous catalyst. The catalyst can be formed by reaction between a metal alkyl and the organic salt of a transition metal. The metal alkyls were n-butyl lithium (in cyclohexane) and triethyl aluminum (in hexane). The metal salts were cobalt and nickel 2-ethyl hexanoates (in hydrocarbon solvents) and platinum and palladium acetyl-acetonates (solids). Hydrogenation was conducted in a 1-liter heavy-wall glass reactor, fitted with a stainless steel flange top and magnetically stirred. A solution of 5 grams of polybutadiene in 500 milliliters of dry cyclohexane was added, and the reactor was closed and purged with nitrogen. The catalyst complex was prepared separately by adding the transition metal salt to the metal alkyl in cyclohexane under nitrogen. The molar ratio of component metals (alkyl to salt) was generally 3.5/1, the optimum in terms of rate and completeness of hydrogenation. The reactor was heated to 70° C., purged with hydrogen, and the catalyst mixture (usually 0.03 moles of transition metal per mole of double bonds) injected through a rubber septum. Hydrogen pressure was increased to 20 psi (gauge) and the reaction allowed to proceed for approximately 4 hours. Hydrogenation proceeds satisfactorily in the initial stages even at room temperature, but the partially hydrogenated polymer soon begins to crystallize. At 70° C., the polymer remains in solution throughout the reaction.

After hydrogenation, the catalyst was decomposed with dilute HCl. The polymer was precipitated with methanol, washed with dilute acid, re-dissolved, re-precipitated and dried under vacuum. Blank experiments with polyethylene in place of polybutadiene confirmed that the washing procedure was sufficient to remove any uncombined catalyst decomposition products.

The Rachapudy et al. article also discloses a method of preparation of a heterogeneous catalyst. A 1-liter high-pressure reactor (Parr Instrument Co.) was used. The catalysts were nickel on kieselguhr (Girdler Co.) and palladium on calcium carbonate (Strem Chemical Co.). Approximately 5 grams of polybutadiene were dissolved in 500 milliliters of dry cyclohexane, the catalyst was added (approximately 0.01 moles metal/mole of double bonds), and the reactor was purged with hydrogen. The reactor was then pressurized with hydrogen and the temperature raised to the reaction temperature for 3 to 4 hours. For the nickel catalyst, the reaction conditions were 700 psi H₂ and 160° C. For palladium, the conditions were 500 psi H₂ and 70° C.

After reaction the hydrogen was removed and the solution filtered at 70° C. The polymer was precipitated with methanol and dried under vacuum.

Additional teachings to hydrogenation processes and catalysts therefor are disclosed in U.S. Pat. Nos. 4,284,835 and 4,980,331, both of which are incorporated herein by reference in their entirety.

The catalysts described herein can be used to hydrogenate hydrocarbons containing unsaturated carbon bonds. The unsaturated carbon bonds which may be hydrogenated include olefinic and acetylenic unsaturated bonds. The process is particularly suitable for the hydrogenation under mild conditions of hydrogenatable organic materials having carbon-to-carbon unsaturation, such as acyclic monoolefins and polyolefins, cyclic monoolefins and polyolefins and mixtures thereof. These materials may be unsubstituted or substituted with additional non-reactive functional groups such as halogens, ether linkages or cyano groups. Exemplary of the types of carbon-to-carbon compounds useful herein are hydrocarbons of 2 to 30 carbon atoms, e.g., olefinic compounds selected from acyclic and cyclic mono-, di- and triolefins. The catalysts of this disclosure are also suitable for hydrogenating carbon-to-carbon unsaturation in polymeric materials, for example, in removing unsaturation from butadiene polymers.

The hydrogenation reaction herein is normally accomplished at a temperature from 40° C. to 160° C. and preferably from 60° C. to 150° C. Different substrates being hydrogenated will require different optimum temperatures, which can be determined by experimentation. The initial hydrogenation pressures may range up to 3,000 psi partial pressure, at least part of which is present due to the hydrogen. Pressures from 1 to 7500 psig are suitable. Preferred pressures are up to 2000 psig, and most preferred pressures are from 100 to 1000 psig are employed. The reactive conditions are determined by the particular choices of reactants and catalysts. The process may be either batch or continuous. In a batch process, reaction times may vary widely, such as between 0.01 second to 10 hours. In a continuous process, reaction times may vary from 0.1 seconds to 120 minutes and preferably from 0.1 second to 10 minutes.

The ratio of catalyst to material being hydrogenated is generally not critical and may vary widely within the scope of the disclosure. Molar ratios of catalyst to material being hydrogenated between 1:1000 and 10:1 are found to be satisfactory; higher and lower ratios, however, are possible.

If desired, the hydrogenation process may be carried out in the presence of an inert diluent, for example a paraffinic or cycloparaffinic hydrocarbon.

Additional teachings to hydrogenation processes and catalysts therefor are disclosed in U.S. Pat. No. 4,980,331, which is incorporated herein by reference in its entirety.

In general, any of the Group VIII metal compounds known to be useful in the preparation of catalysts for the hydrogenation of ethylenic unsaturation can be used separately or in combination to prepare the catalysts. Suitable compounds, then, include Group VIII metal carboxylates having the formula (RCOO)ₙM, wherein M is a Group VIII metal, R is a hydrocarbyl radical having from 1 to 50 carbon atoms, preferably from 5 to 30 carbon atoms, and n is a number equal to the valence of the metal M; alkoxides having the formula (RCO)ₙM, wherein M is again a Group VIII metal, R is a hydrocarbon radical having from 1 to 50 carbon atoms, preferably from 5 to 30 carbon atoms, and n is a number equal to the valence of the metal M; chelates of the metal prepared with beta-ketones, alpha-hydroxycarboxylic acids beta-hydroxycarboxylic acids, beta-hydroxycarbonyl compounds and the like; salts of sulfur-containing acids having the general formula M(SOₓ)ₙ and partial esters thereof; and salts of aliphatic and aromatic sulfonic acids having from 1 to 20 carbon atoms. Preferably, the Group VIII metal will be selected from the group consisting of nickel and cobalt. Most preferably, the Group VIII metal will be nickel.

The metal carboxylates useful in preparing the catalyst include Group VIII metal salts of hydrocarbon aliphatic acids, hydrocarbon cycloaliphatic acids and hydrocarbon aromatic acids. Examples of hydrocarbon aliphatic acids include hexanoic acid, ethylhexanoic acid, heptanoic acid, octanoic acid, nonanoic acid, decanoic acid, dodecanoic acid, myristic acid, palmitic acid, stearic acid, oleic acid, linoleic acid, and rhodinic acid. Examples of hydrocarbon aromatic acids include benzoic acid and alkyl-substituted aromatic acids in which the alkyl substitution has from 1 to 20 carbon atoms. Examples of cycloaliphatic acids include naphthenic acid, cyclohexylcarboxylic acid, and abietic-type resin acids. Suitable chelating agents which may be combined with various Group VIII metal compounds thereby yielding a Group VIII metal chelate compound useful in the preparation of the catalyst include beta-ketones, alpha-hydroxycarboxylic acids, beta-hydroxy carboxylic acids, and beta-hydroxycarbonyl compounds. Examples of beta-ketones that may be used include acetylacetone, 1,3-hexanedione, 3,5-nonadione, methylacetoacetate, and ethylacetoacetate. Examples of alpha-hydroxycarboxylic acids that may be used include lactic acid, glycolic acid, alpha-hydroxyphenylacetic acid, alpha-hydroxy-alpha-phenylacetic acid, and alpha-hydroxycyclohexylacetic acid. Examples of beta-hydroxycarboxylic acids include salicylic acid, and alkyl-substituted salicyclic acids. Examples of beta-hydroxylcarbonyl compounds that may be used include salicylaldehyde, and θ-hydroxyacetophenone. The metal alkoxides useful in preparing the catalysts include Group VIII metal alkoxides of hydrocarbon aliphatic alcohols, hydrocarbon cycloaliphatic alcohols and hydrocarbon aromatic alcohols. Examples of hydrocarbon aliphatic alcohols include hexanol, ethylhexanol, heptanol, octanol, nonanol, decanol, and dodecanol. The Group VIII metal salts of sulfur-containing acids and partial esters thereof include Group VIII metal salts of sulfonic acid, sulfuric acid, sulphurous acid, and partial esters thereof. Of the sulfonic acids, aromatic sulfonic acids such as benzene sulfonic acid, p-toluene sulfonic acid, are particularly useful.

In general, any of the alkylalumoxane compounds known to be useful in the preparation of olefin polymerization catalysts may be used in the preparation of the hydrogenation catalyst. Alkylalumoxane compounds useful in preparing the catalyst may, then, be cyclic or linear. Cyclic alkylalumoxanes may be represented by the general formula (R—Al —O)ₘ while linear alkylalumoxanes may be represented by the general formula R(R—Al—O)ₙAlR₂. In both of the general formulae R will be an alkyl group having from 1 to 8 carbon atoms such as, for example, methyl, ethyl, propyl, butyl, and pentyl, m is an integer from 3 to 40, and n is an integer from 1 to 40. In a preferred embodiment, R will be methyl, m will be a number from 5 to 20 and n will be a number from 10 to 20. As is well known, alkylalumoxanes may be prepared by reacting an aluminum alkyl with water. Usually the resulting product will be a mixture of both linear and cyclic compounds.

Contacting of the aluminum alkyl and water may be accomplished in several ways. For example, the aluminum alkyl may first be dissolved in a suitable solvent such as toluene or an aliphatic hydrocarbon and the solution then contacted with a similar solvent containing relatively minor amounts of moisture. Alternatively, an aluminum alkyl may be contacted with a hydrated salt, such as hydrated copper sulfate or ferrous sulfate. When this method is used, a hydrated ferrous sulfate is frequently used. According to this method, a dilute solution of aluminum alkyl in a suitable solvent such as toluene is contacted with hydrated ferrous sulfate. In general, 1 mole of hydrated ferrous sulfate will be contacted with from 6 to 7 moles of the aluminum trialkyl. When aluminum trimethyl is the aluminum alkyl actually used, methane will be evolved as conversion of the aluminum alkyl to an alkylalumoxane occurs.

In general, any of the Group Ia, IIa or IIIa metal alkyls or hydrides known to be useful in preparing hydrogenation catalysts in the prior art may be used to prepare the catalyst. In general, the Group Ia, IIa or IIIa metal alkyls will be peralkyls with each alkyl group being the same or different containing from 1 to 8 carbon atoms and the hydrides will be perhydrides although alkylhydrides should be equally useful. Aluminum, magnesium and lithium alkyls and hydrides are particularly useful and these compounds are preferred for use in preparing the catalyst. Aluminum trialkyls are most preferred.

The one or more alkylalumoxanes and the one or more Group Ia, IIa or IIIa metal alkyls or hydrides may be combined and then contacted with the one or more Group VIII metal compounds or the one or more alkylalumoxanes and the one or more Group Ia, IIa or IIIa metal alkyls or hydrides may be sequentially contacted with the one or more Group VIII metal compounds with the proviso that when sequential contacting is used, the one or more alkylalumoxanes will be first contacted with the one or more Group VIII metal compounds. Sequential contacting is preferred. With respect to the contacting step the two different reducing agents; i.e., the alkylalumoxanes and the alkyls or hydrides, might react with the Group VIII metal compound in such a way as to yield different reaction products. The Group Ia, IIa and IIIa metal alkyls and hydrides are a stronger reducing agent than the alkylalumoxanes, and, as a result, if the Group VIII metal is allowed to be completely reduced with a Group Ia, IIa or IIIa metal alkyl or hydride, the alkylalumoxanes might make little or no contribution. If the Group VIII metal is first reduced with one or more alkylalumoxanes however, the reaction product obtained with the alumoxane might be further reduced or otherwise altered by reaction with a Group Ia, IIa or IIIa metal alkyl or hydride.

Whether contacting is accomplished concurrently or sequentially, the one or more alkylalumoxanes will be combined with the one or more Group VIII metal compounds at a concentration sufficient to provide an aluminum to Group VIII metal atomic ratio within the range from 1.5:1 to.20:1 and the one or more Group Ia, IIa or IIIa metal alkyls or hydrides will be combined with one or more Group VIII metal compounds at a concentration sufficient to provide a Group Ia, IIa or IIIa metal to Group VIII metal atomic ratio within the range from 0.1:1 to 20:1. Contact between the one or more Group VIII compounds and the one or more alkylalumoxanes and the one or more alkyls or hydrides will be accomplished at a temperature within the range from 20° C. and 100° C. Contact will typically be continued for a period of time within the range from 1 to 120 minutes. When sequential contacting is used, each of the two contacting steps will be continued for a period of time within this same range.

In general, the hydrogenation catalyst will be prepared by combining the one or more Group VIII metal compounds with the one or more alkylalumoxanes and the one or more Group Ia, IIa or IIIa metal alkyls or hydrides in a suitable solvent. In general, the solvent used for preparing the catalyst may be anyone of those solvents known in the prior art to be useful as solvents for unsaturated hydrocarbon polymers. Suitable solvents include aliphatic hydrocarbons, such as hexane, heptane, and octane, cycloaliphatic hydrocarbons such as cyclopentane, and cyclohexane, alkyl-substituted cycloaliphatic hydrocarbons such as methylcyclopentane, methylcyclohexane, and methylcyclooctane, aromatic hydrocarbons such as benzene, hydroaromatic hydrocarbons such as decalin and tetralin, alkyl-substituted aromatic hydrocarbons such as toluene and xylene, halogenated aromatic hydrocarbons such as chlorobenzene, and linear and cyclic ethers such as the various dialkyl ethers, polyethers, particularly diethers, and tetrahydrofuran. Suitable hydrogenation catalysts will usually be prepared by combining the catalyst components in a separate vessel prior to feeding the same to the hydrogenation reactor.

In the above detailed description, the specific embodiments of this disclosure have been described in connection with its preferred embodiments. However, to the extent that the above description is specific to a particular embodiment or a particular use of this disclosure, this is intended to be illustrative only and merely provides a concise description of the exemplary embodiments. Accordingly, the disclosure is not limited to the specific embodiments described above, but rather, the disclosure includes all alternatives, modifications, and equivalents falling within the true scope of the appended claims. Various modifications and variations of this disclosure will be obvious to a worker skilled in the art and it is to be understood that such modifications and variations are to be included within the purview of this application and the spirit and scope of the claims.

All reactions in the following examples were performed using as-received starting materials without any purification.

### EXAMPLES

### Example 1

### Synthesis of telechelic hydroxyl-Terminated poly(1,5-cyclooctadiene) (HO-PCOD)

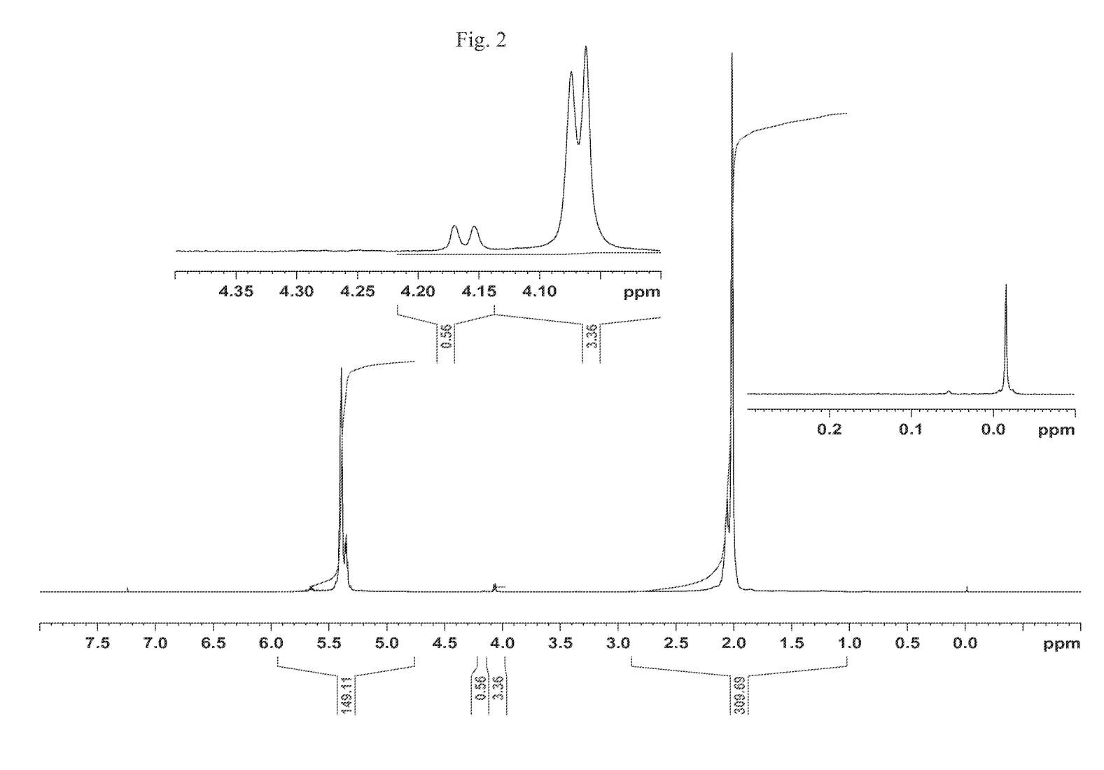

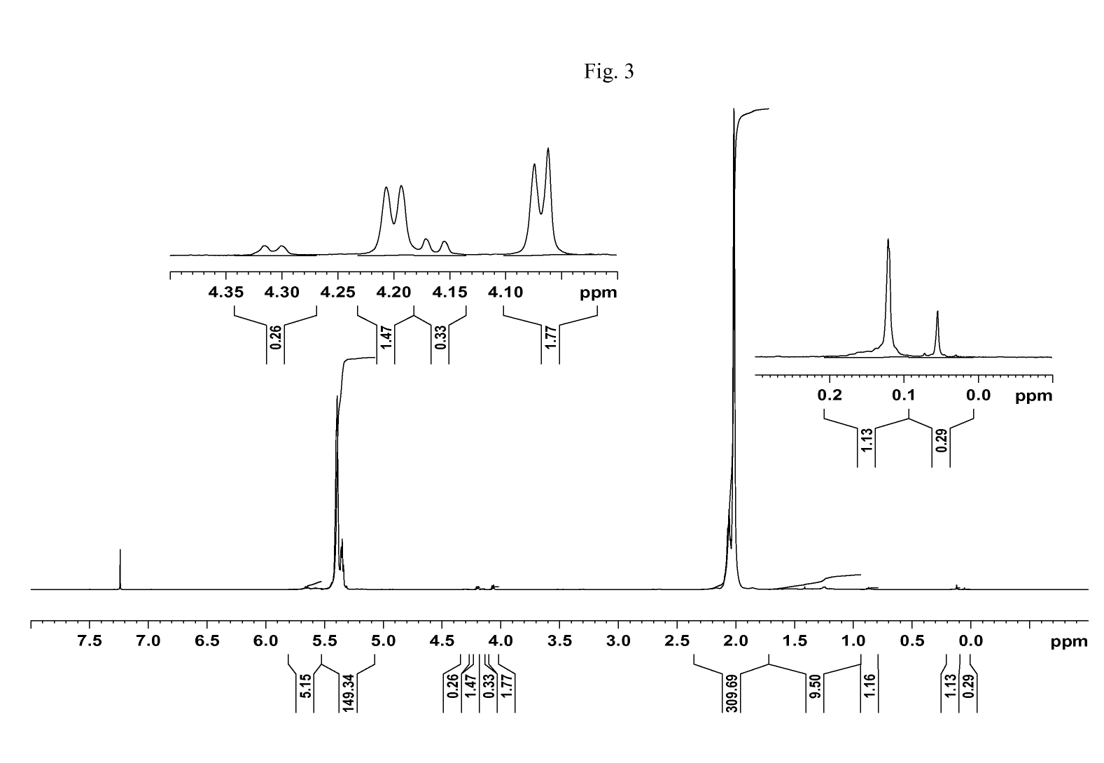

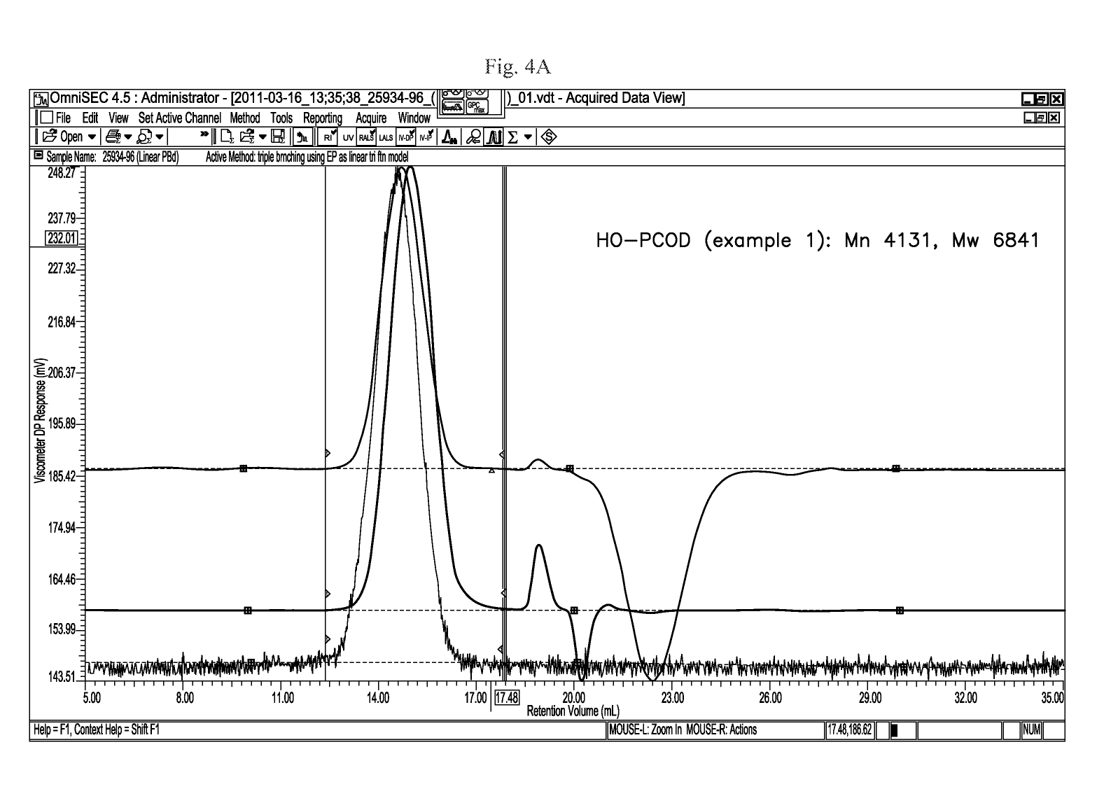

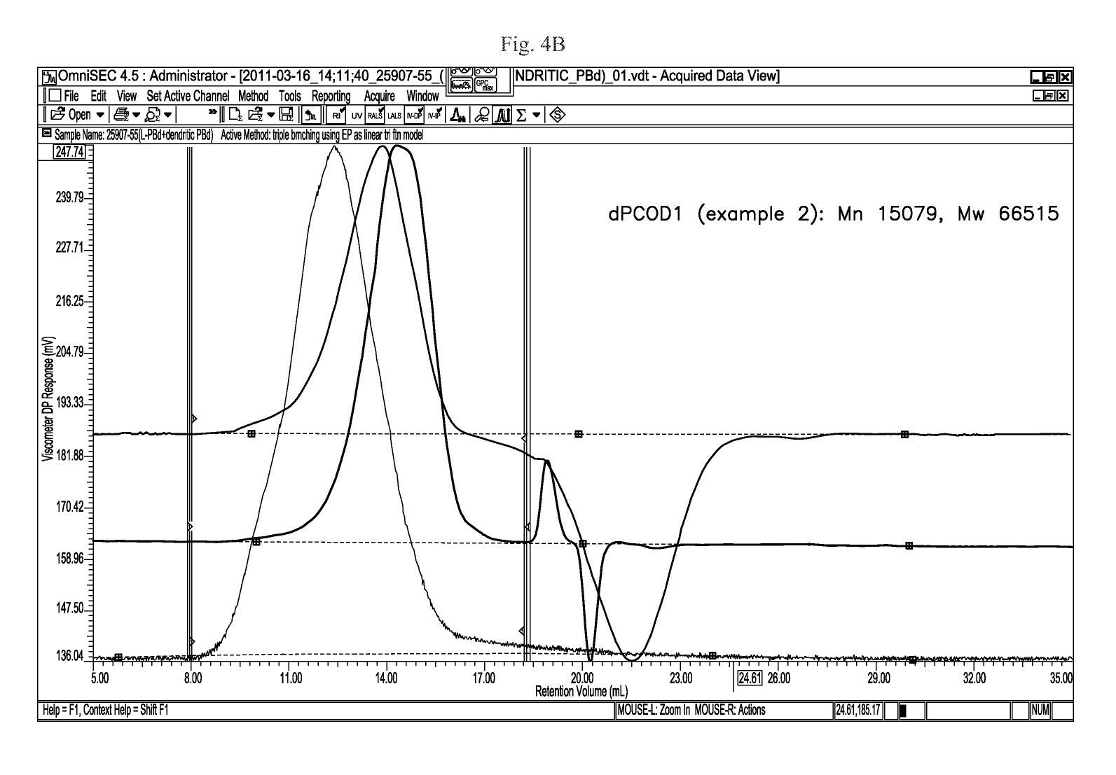

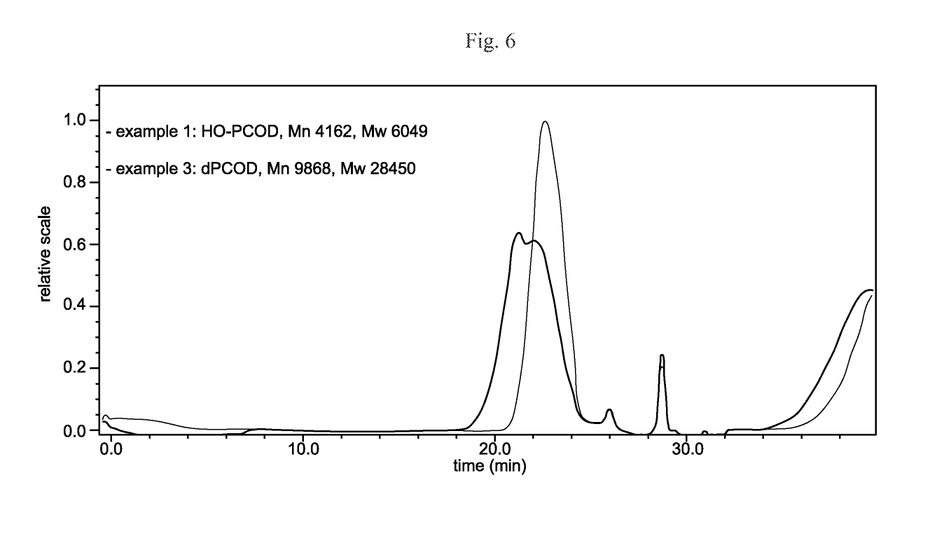

In a nitrogen filled glovebox, to a 50 milliliter round-bottomed flask, 1,5-cyclooctadiene (14 grams) and 1,4-diacetoxy-2-butene (0.891 grams) were mixed with toluene (25 milliliters). The mixture was heated to 50° C. with stirring, forming a homogeneous solution. A 2^{nd} generation Grubbs catalyst (0.023 grams) was added. The reaction was let go for 19 hours at 50° C. and then cooled down and quenched by vinyl ethyl ether. The mixture was stirred with thiol-silica and then filtered. The filtrate was concentrated and brought to dryness under vacuum overnight. The polymer was then dissolved in 120 milliliters of tetrahydrofuran and cooled to 0° C. A 32 milliliter aliquot of 25% sodium methoxide in methanol was added to the THF solution. This was stirred for overnight at ambient temperature. The reaction mixture was poured into 800 milliliters of slightly acidic methanol and stirred overnight. The liquid phase was decanted, and the polymer was washed three times with methanol/HCl, methanol/water, and anhydrous methanol successively, and dried under vacuum. Yield 11.23 grams. FIG. 2 depicts ¹H NMR spectra of the telechelic hydrocarbon polymer (HO-PCOD) of this Example 1 (CDCl₃, 27° C.). FIG. 4 depicts GPC-3D (gel permeation chromatography) of the telechelic hydrocarbon polymer (HO-PCOD) and the dendritic hydrocarbon polymer (dPCOD1) of this Example 1 and Example 2 (THF, r.t.). FIG. 6 depicts GPC of the telechelic hydrocarbon polymer (HO-PCOD) and the dendritic hydrocarbon polymer (dPCOD2) of this Example 1 and Example 3 (THF, r.t.).

### Example 2

### Synthesis of dendritic poly(1,5-cyclooctadiene) (dPCOD1)

In a nitrogen filled glovebox, to a 100 milliliter round-bottomed flask, HO-PCOD prepared in Example 1 (0.523 grams) was mixed with cyclohexane (10 milliliters). The mixture was heated to 50° C. with stirring, forming a homogeneous solution. Pyridine (0.085 grams) was added. Methyltrichlorosilane (0.008 grams) was diluted in cyclohexane (20 milliliters) and the solution was then added dropwise by an addition funnel. After 3 hours, the cloudy reaction mixture was cooled down and filtered. The product was precipitated out of methanol and dried in vacuum overnight. FIG. 3 depicts ¹H NMR spectra of the dendritic hydrocarbon polymer (dPCOD1) of this Example 2 (CDCl₃, 27° C.). FIG. 4 depicts GPC-3D (gel permeation chromatography) of the telechelic hydrocarbon polymer (HO-PCOD) and the dendritic hydrocarbon polymer (dPCOD1) of this Example 2 and Example 1(THF, r.t.).

### Example 3

### Synthesis of dendritic poly(1.5-cyclooctadiene) (dPCOD2)

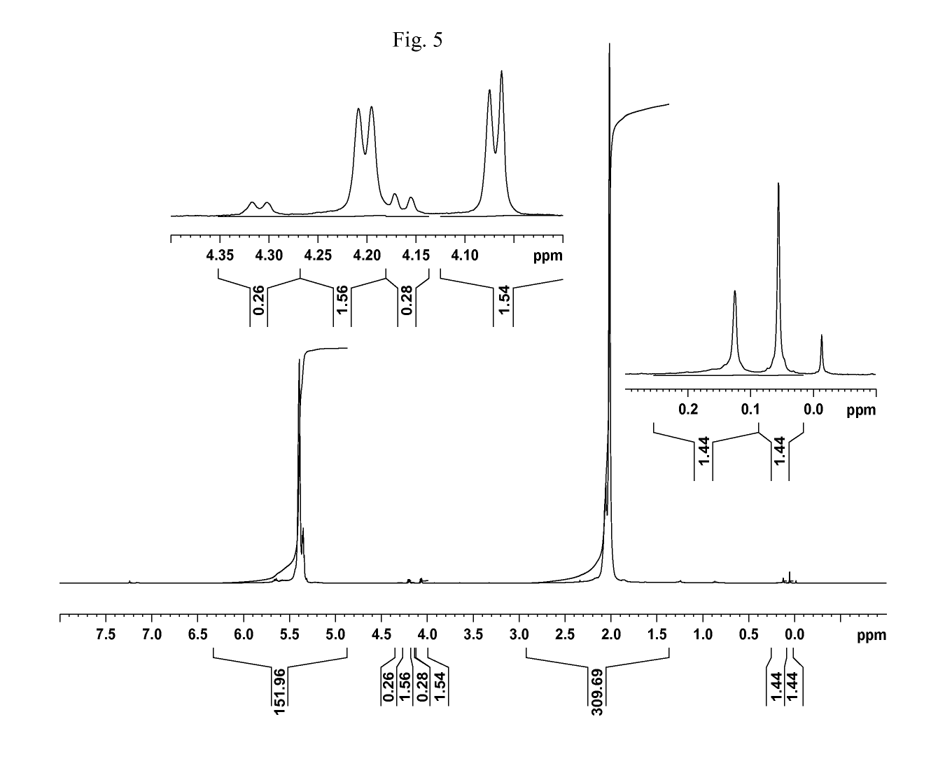

In a nitrogen filled glovebox, to a 100 milliliter round-bottomed flask, HO-PCOD prepared in Example 1 (1.5 grams) and anhydrous pyridine (0.06 grams) were mixed with toluene (30 milliliters). The mixture was stirred vigorously to a homogeneous solution. Methyltrichlorosilane (0.023 grams) was diluted in toluene (20 milliliters) and the solution was then added dropwise by an addition funnel. The mixture tuned cloudy in 5 minutes. The addition was complete in 30 minutes, after which the mixture was maintained at ambient temperature overnight. The reaction was then quenched with methanol. The mixture was stripped under high vacuum, yielding 1.44 grams of product. FIG. 5 depicts ¹H NMR spectra of the dendritic hydrocarbon polymer (dPCOD2) of this Example 3 (CDCl₃, 27° C.). FIG. 6 depicts GPC of the telechelic hydrocarbon polymer (HO-PCOD) and the dendritic hydrocarbon polymer (dPCOD2) of this Example 3 and Example 1 (THF, r.t.).

### Example 4

### Hydrogenation of dPOD2 (Product: dPE1)

To a 100 milliliter round-bottomed flask, dPCOD2 prepared in Example 3 (0.7 grams), tripropylamine (9.46 grams), p-toluenesulfonylhydrazide (11 grams) and 2,6-di-tert-butyl-4-methylphenol (0.013 grams) were mixed with o-xylene (65 milliliters). The mixture was heated to reflux with stirring, forming a homogeneous solution. After overnight, the mixture was cooled down and filtered. The solid was washed with methanol three times and dried in vacuum at 80° C. overnight.

### Example 5

### Hydrogenation of HO-PCOD (Product: HO-PE)

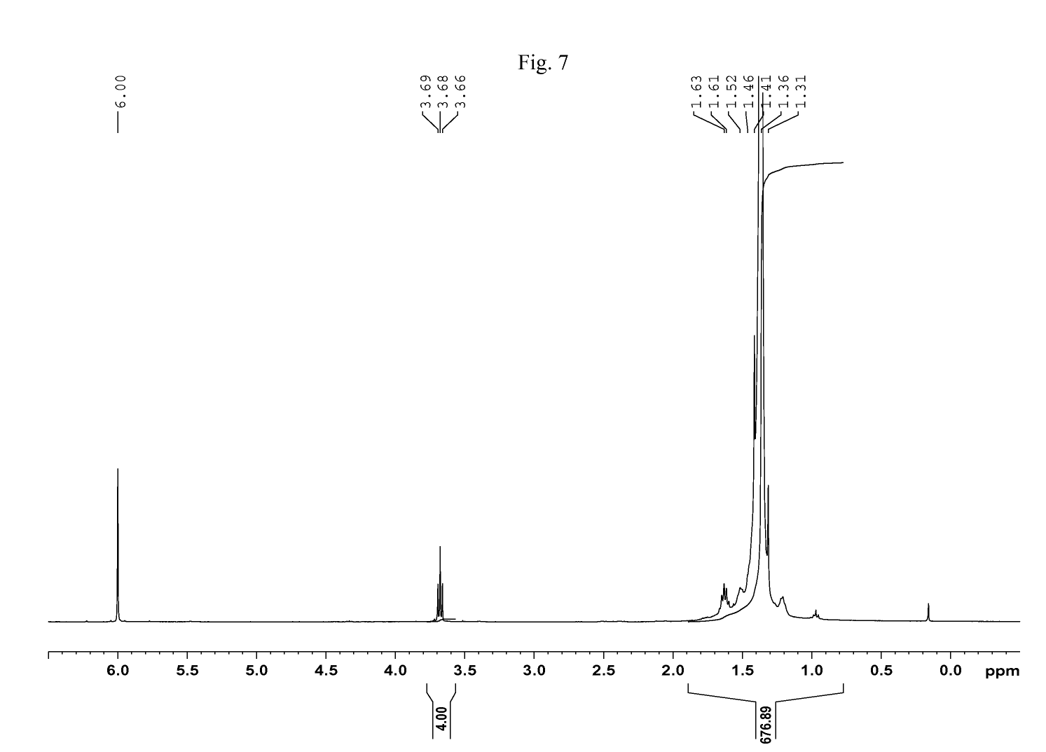

To a 250 milliliter round-bottomed flask, HO-PCOD prepared in Example 1 (2 grams), tripropylamine (12 grams) and p-toluenesulfonylhydrazide (15 grams) was mixed with o-xylene (100 milliliters). The mixture was heated to reflux with stirring, forming a homogeneous solution. After overnight, the mixture was cooled down and filtered. The solid was washed with methanol three times and dried in vacuum at 80° C. overnight. FIG. 7 depicts ¹H NMR spectra of the hydrogenated telechelic hydrocarbon polymer (HO-PE) of this Example 5 (TCE, 115° C.).

### Example 6

### Synthesis of dendritic polyethylene (dPE2)

In a nitrogen filled glovebox, to a 250 milliliter round-bottomed flask, the hydrogenated telechelic hydrocarbon polymer (HO-PE) prepared in Example 5 (0.6 gram) and hexamethyldisilazane (0.24 gram) were mixed with o-xylene (100 milliliters). The mixture was heated to 105° C. with stirring, forming a homogeneous solution. Phenyltrichlorosilane (0.0125 gram) was diluted in o-xylene (25 milliliters) and the solution was added dropwise by an addition funnel. After 20 hours, the reaction mixture was cooled down and the product was precipitated out of methanol and dried in vacuum overnight.

### Example 7

### Synthesis of telechelic bromo-Terminated polycyclooctene (Br-PCOE)

In a nitrogen-filled glovebox, to a 250 milliliter round-bottomed flask, cyclooctene (25 grams) and 1,4-dibromo-trans-2-butene (1.449 grams) were mixed with toluene (125 milliliters). The 2^{nd} generation Grubbs catalyst (0.0247 gram) was dissolved in 5 milliliters toluene and added while the mixture was vigorously stirred. The mixture was then heated to 50° C. After 6 hours, the mixture was cooled down, quenched by vinyl ethyl ether, stirred with thiol-silica and then filtered. The filtrate was concentrated and methanol was added to precipitate the product out. The product was washed by methanol several times and dried in vacuum overnight. The yield was 24.5 grams.

### Example 8

### Synthesis of dendritic polycyclooctene (dPCOE1)

In a nitrogen filled glovebox, to a 100 milliliter round-bottomed flask, phloroglucinol (0.013 gram) was mixed with THF and sodium hydride (0.05 gram). The mixture was stirred for 45 minutes, then a THF solution of Br-PCOE prepared in Example 7 (1.0 gram) was added dropwise with stirring. The mixture was heated to 50° C. for 3 hours, and then to 55° C. for 61 hours. The reaction mixture became very viscous. The reaction was quenched by methanol and THF was removed under vacuum. The product was precipitated out of methanol, washed, and dried in vacuum overnight.

### Example 9

### Hydrogenation of dPCOE1 (Product: dPE3)

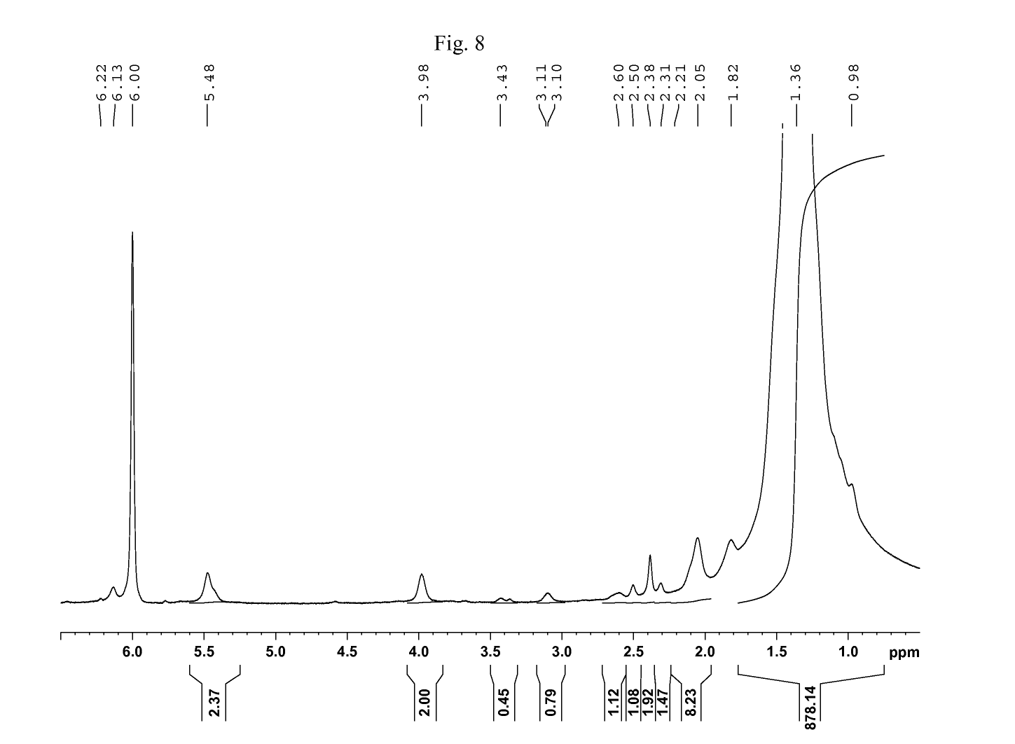

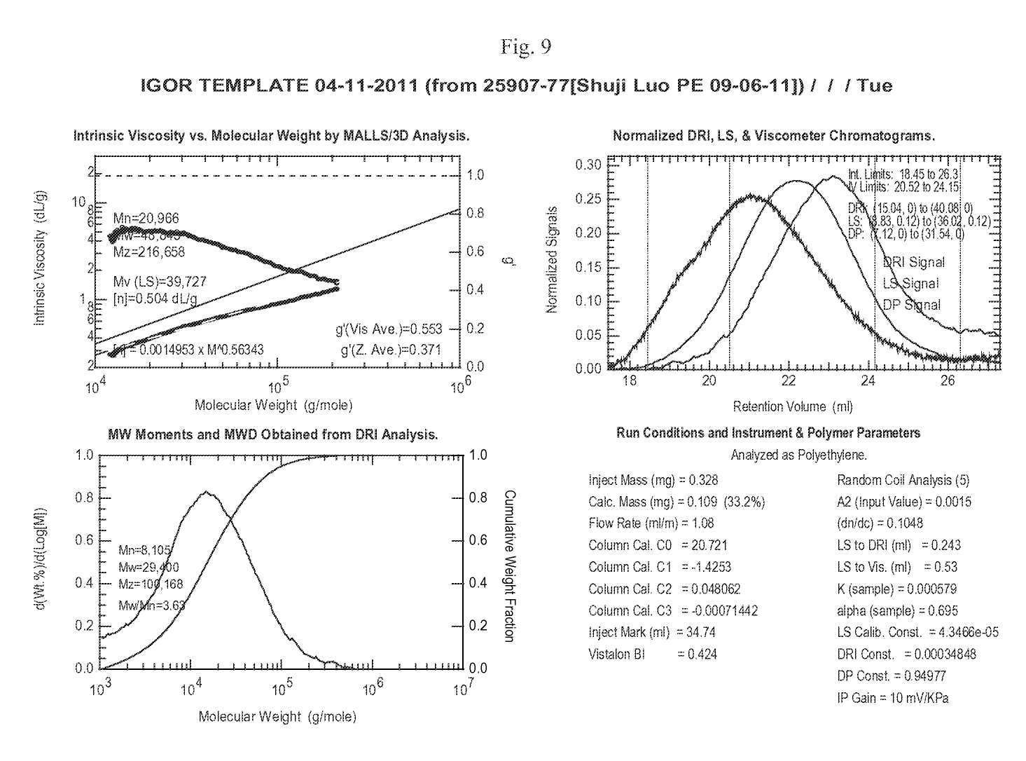

To a 250 milliliter round-bottomed flask, dPCOE1 prepared in Example 8 (0.81 gram), tributylamine (5.4 grams), p-toluenesulfonylhydrazide (5.0 grams) and 2,6-di-tert-butyl-4-methylphenol (0.13 gram) were mixed with o-xylene (100 milliliters). The mixture was heated to reflux with stirring. After overnight, the mixture was cooled down. Solvent was removed by vacuum distillation. The solid was washed with methanol, water and acetone and dried in vacuum at 80° C. overnight. FIG. 8 depicts ¹H NMR spectra of the dendritic hydrocarbon polymer (dPE3) of this Example 9 (TCE, 115° C.). FIG. 9 depicts GPC-3D of the dendritic hydrocarbon polymer (dPE3) of this Example 9 (1,3,5-trichlorobenzene or TCB, 135° C.).

### Example 10

### Synthesis of dendritic polycyclooctene (dPCOE2) and hydrogenation (dPE4)

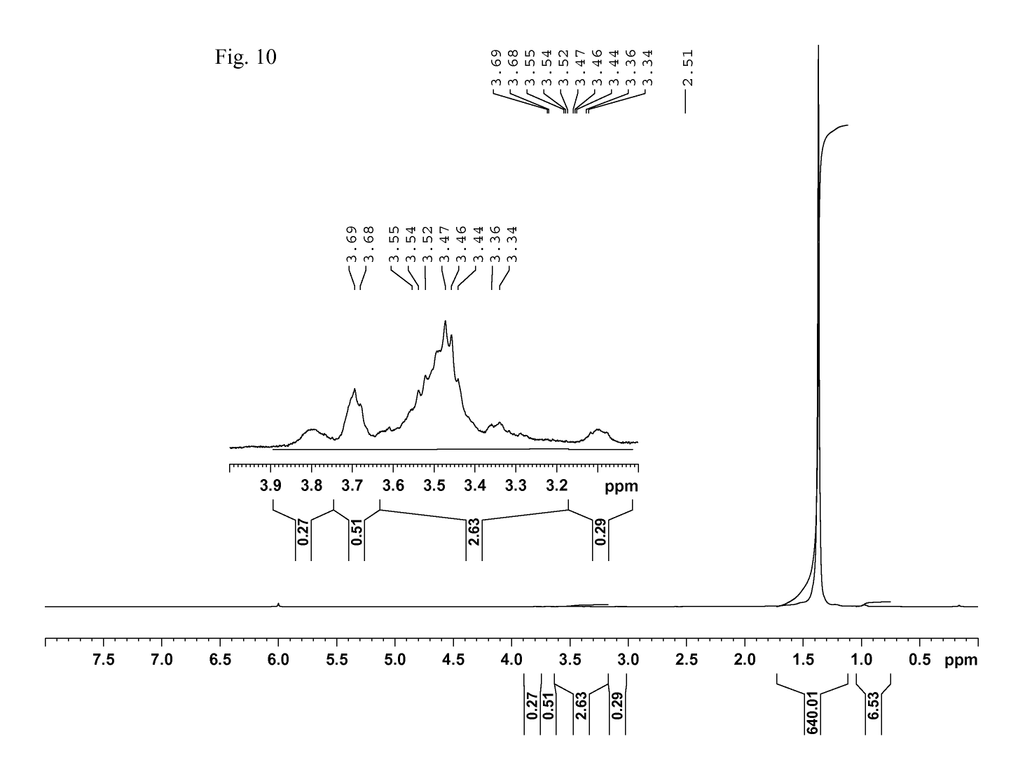

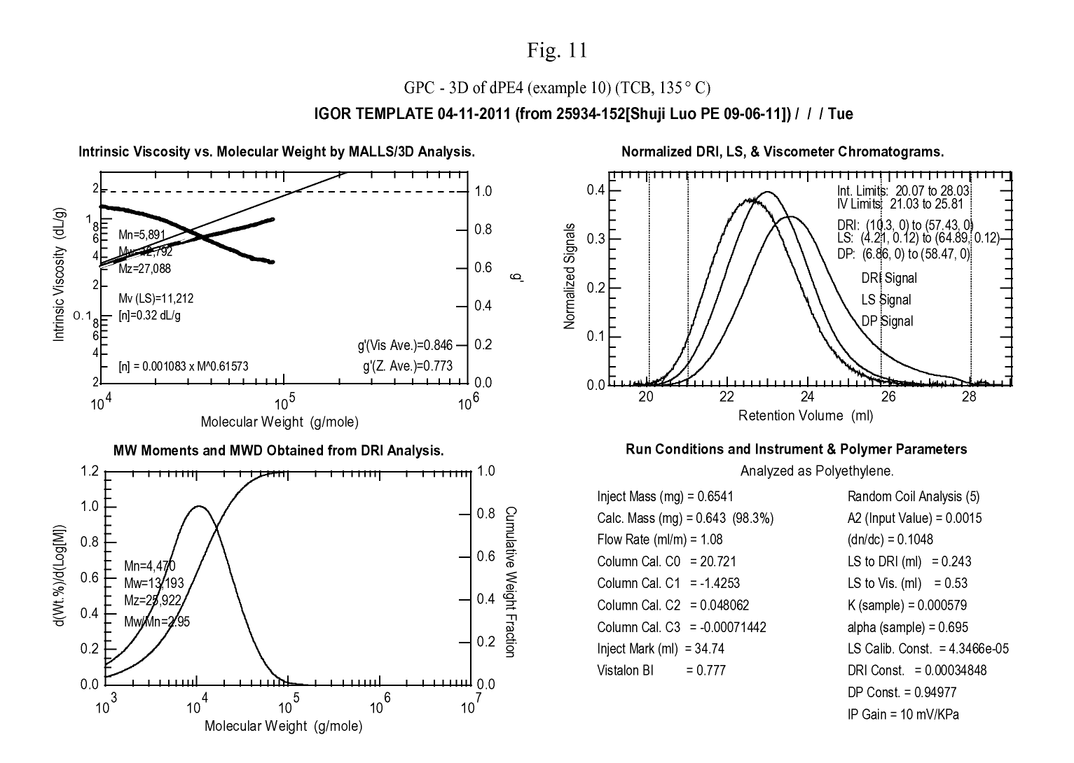

In a nitrogen filled glovebox, to a 100 milliliter round-bottomed flask, 1,2,6-hexanetriol (0.055 gram) was mixed with THF, sodium hydride (0.165 gram), tetrabutylammonium bisulfate (0.056 gram) and Br-PCOE prepared in Example 7 (4.0 grams). The mixture was stirred for 30 minutes at ambient temperature and was then heated to 60° C. After 19 hours, the reaction mixture was cooled down. THF was removed under vacuum. The product was precipitated and washed by methanol, then dried in vacuum overnight. The product was hydrogenated using the same method in Example 9. FIG. 10 depicts ¹H NMR spectra of the dendritic hydrocarbon polymer (dPE4) of this Example 10 (TCE, 115° C.). FIG. 11 depicts GPC-3D of the dendritic hydrocarbon polymer (dPE4) of this Example 10 (TCB, 135° C.).

### Example 11

### Synthesis of dendritic polycyclooctene (dPCOE3) and hydrogenation (dPE5)

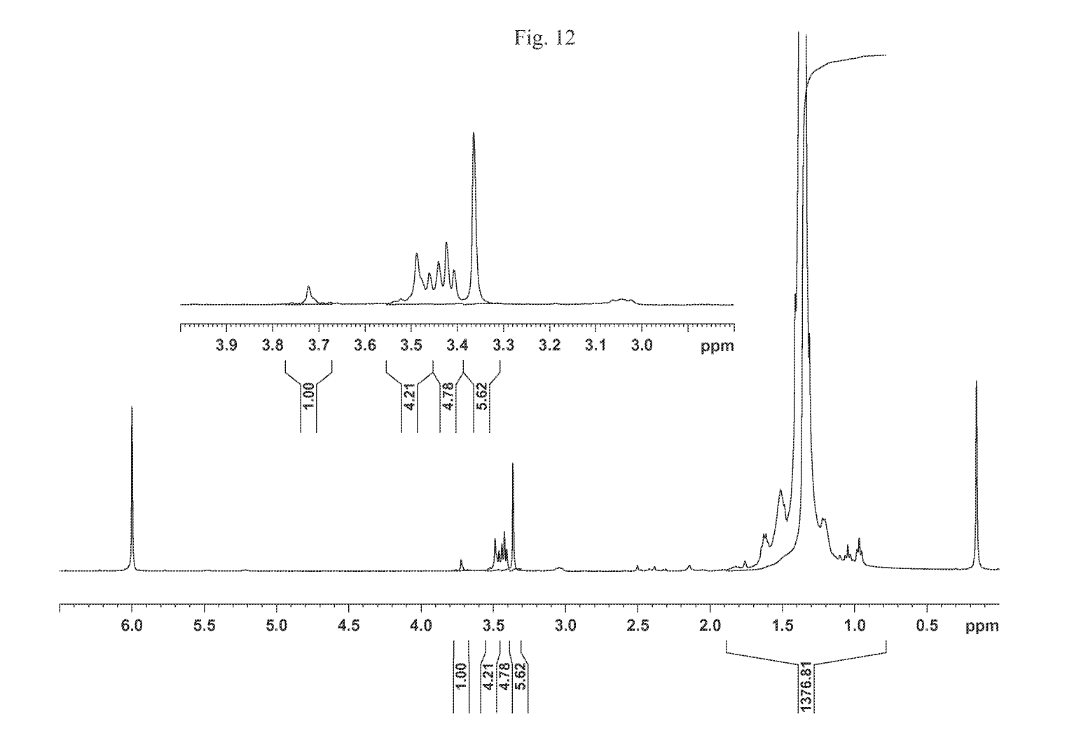

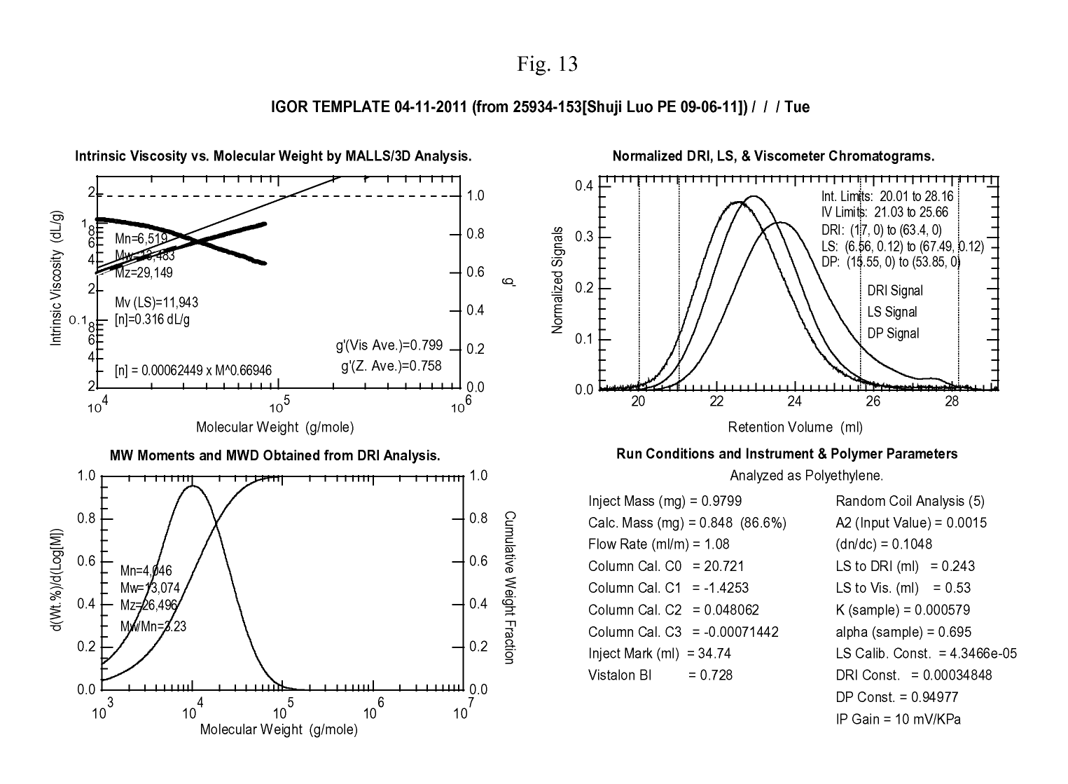

In a nitrogen filled glovebox, to a 100 milliliter round-bottomed flask, pentaerythritol (0.056 gram) was mixed with THF, sodium hydride (0.165 gram) and tetrabutylammonium bisulfate (0.056 gram). The mixture was stirred for 45 minutes, then a THF solution of Br-PCOE prepared in Example 7 (4.0 grams) was added dropwise with stirring. The mixture was heated to 60° C. After 18 hours, the reaction mixture was cooled down. THF was removed under vacuum. The product was precipitated and washed by methanol, then dried in vacuum overnight. The product was hydrogenated using the same method in Example 9. FIG. 12 depicts ¹H NMR spectra of the dendritic hydrocarbon polymer (dPE5) of this Example 11 (TCE, 115° C.). FIG. 13 depicts GPC-3D of the dendritic hydrocarbon polymer (dPE5) of this Example 11 (TCB, 135° C.).

### Example 12

### Synthesis of dendritic polyethytlene (dPE6)

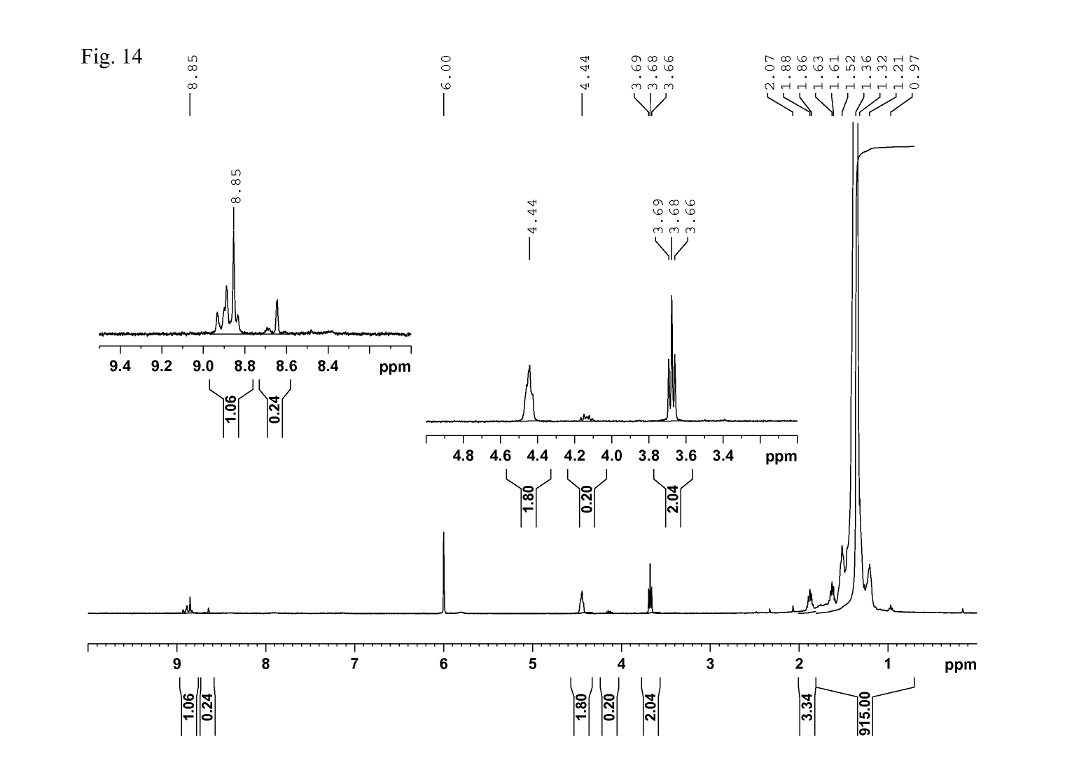

In a nitrogen filled glovebox, to a 100 milliliter round-bottomed flask, HO-PE (0.4 gram, FW 6555, 0.06102 millimole) prepared in Example 5 was mixed with o-xylene (20 milliliters) and pyridine (0.398 gram). The mixture was stirred and heated to 100° C. A solution of trimesoyl chloride (0.00862 gram, 0.03246 millimole) in o-xylene (20 milliliters) was then added to the flask dropwise through an addition funnel. After 1.5 hours the addition was complete. The mixture was maintained at 100° C. for 18 hours, and then cooled down. The product was precipitated and washed by methanol, then dried in vacuum overnight. FIG. 14 depicts ¹H NMR spectra of this dendritic hydrocarbon polymer (dPE6) of this Example 12 (TCE, 110° C.).

### Example 13

### Blending and Testing of dendritic PE Samples

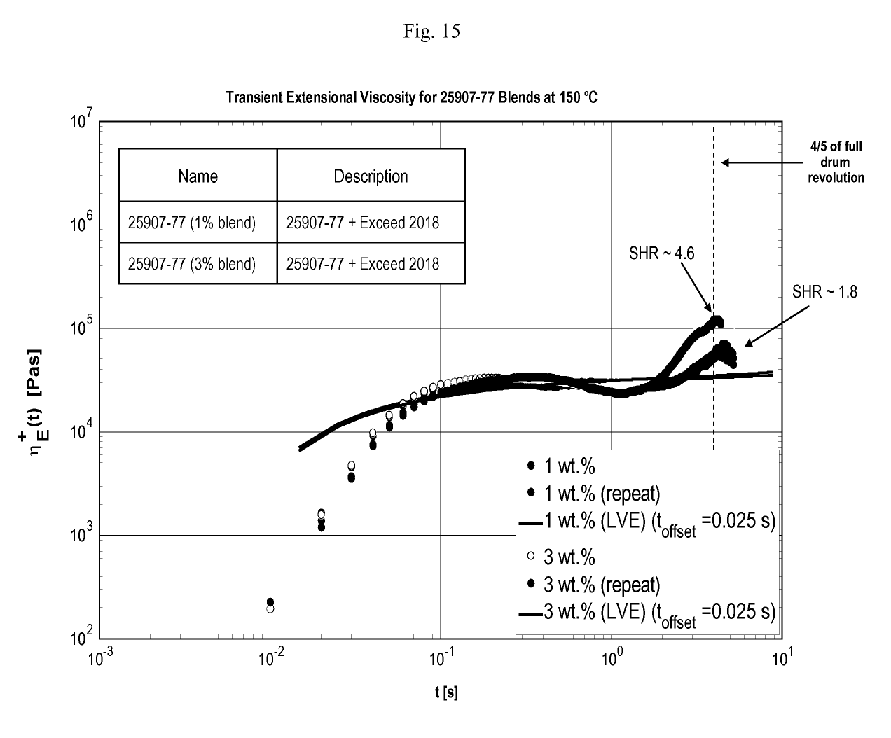

The dPE3 product of Example 9 was blended with Exceed 2018 (mLLDPE, ExxonMobil Chemical) at 1 and 3 wt % using a DSM twin-screw miniature extrusion mixer running at 180-185° C., 50 RPM, and for 3 minutes. 0.1 wt % of BHT stabilizer was added in each batch. All blends were compression molded at 190° C. for 10 minutes to prepare testing plaques. A SER2 (Sentmanat Extensional Rheometer 2) attachment on an ARES rheometer was used to measure the extensional strain hardening of these plaques at 150° C. Strain hardening could be found in blends containing Example 9 with a strain hardening ratio of 1.8 in the 1% blend and a strain hardening ratio of 4.6 in the 3% blend. FIG. 15 depicts SER (Sentmanat Extension Rheometer) of 1% and 3% dPE3 of Example 9 in Exceed 2018 (150° C.).

### PCT and EP Clauses:

1. A process for making a dendritic hydrocarbon polymer, said process comprising:

reacting an amount of one or more telechelic hydrocarbon polymers with an amount of one or more multifunctional coupling agents under conditions sufficient to produce said dendritic hydrocarbon polymer.

2. A process for making a dendritic hydrocarbon polymer, said process comprising:

polymerizing, by ring opening metathesis polymerization, an amount of one or more cyclic olefins with an amount of one or more bi-functional alkene chain terminating agents in the presence of a metathesis catalyst and under conditions sufficient to produce one or more telechelic hydrocarbon polymers; and

reacting an amount of the one or more telechelic hydrocarbon polymers with an amount of one or more multifunctional coupling agents under conditions sufficient to produce said dendritic hydrocarbon polymer.

3. The process of clauses 1 and 2 wherein the dendritic hydrocarbon polymer is a dendritic polyolefin.

4. The process of clauses 1-3 wherein the one or more telechelic hydrocarbon polymers are selected from hydroxyl-terminated poly(1,5-cyclooctadiene) (HO-PCOD), hydroxyl or carboxy-terminated polycyclooctene (HOOC-PCOE), bromo-terminated polycyclooctene (Br-PCOE), and hydroxyl-terminated polyethylene (HO-PE); and the one or more multifunctional coupling agents are selected from trifunctional silanes, polyols, polycarboxylic acids and tricarbonyl chlorides; wherein the trifunctional silanes are selected from trichloromethylsilane, trichloroethoxysilane, 1-dichloromethyl-2-chlorodimethyl-disiloxane, 1-dichloromethylsilyl-2-chlorodimethylsilyl ethane, and one or more compounds within the formula X₃Si(CH₂)ₙH and X₂(CH₃)₂Si—(CH₂)ₙ—Si(CH₃)₂X, wherein n is greater than or equal to 0, and X is a halogen or an alkoxy; the polyols are selected from glycerol, 1,2,6-hexanetriol, 1,3,5-benzenetriol, 1,1,1-tris(hydroxymethyl)propane, and pentaerythritol; and the polycarboxylic acids are selected from 1,2,4-benzenecarboxylic anhydride, 1,2,4-benzenecarboxylic acid, 1,3,5-benzenetricarboxylic acid, benzophenone-3,3′,4,4′-tetracarboxylic dianhydride, and trimesoyl chloride.

5. The process of clause 4 wherein the one or more telechelic hydrocarbon polymers and one or more trifunctional coupling agents are present in an equivalent concentration ratio (telechelic hydrocarbon polymer/trifunctional silane coupling agent) of from 1.7 to 3.0 equivalents.

6. The process of clauses 2-5 wherein the one or more cyclic olefins are selected from cyclooctene, 1,5-cyclooctadiene, 1,5-dimethylcyclooctadiene, norbornene, cyclopentene, and 1,5,9-cyclododecatriene; and the one or more bi-functional alkenes are selected from 1,4-diacetoxy-2-butene, 1,4-dibromo-2-butene, 1,4-dichloro-2-butene, maleic acid, and 9-octadecene-1,18-diol.

7. The process of clauses 2-6 wherein the one or more cyclic olefins and one or more bi-functional alkenes are present in a molar concentration ratio (cyclic olefin/bi-functional alkene) of from 5 to 2500.

8. The process of clauses 2-7 wherein the metathesis catalyst is a Grubbs 2^{nd} generation catalyst

9. A dendritic hydrocarbon polymer produced by the process of clauses 1-8.

10. A process for making a substantially saturated dendritic hydrocarbon polymer, said process comprising:

reacting an amount of one or more telechelic hydrocarbon polymers with an amount of one or more multifunctional coupling agents under conditions sufficient to produce a dendritic hydrocarbon polymer; and

hydrogenating the dendritic hydrocarbon polymer to produce the substantially saturated dendritic hydrocarbon polymer.

11. A process for making a substantially saturated dendritic hydrocarbon polymer, said process comprising:

polymerizing, by ring opening metathesis polymerization, an amount of one or more cyclic olefins with an amount of one or more bi-functional alkene chain terminating agents in the presence of a metathesis catalyst and under conditions sufficient to produce one or more telechelic hydrocarbon polymers;

reacting an amount of the one or more telechelic hydrocarbon polymers with an amount of one or more multifunctional coupling agents under conditions sufficient to produce a dendritic hydrocarbon polymer; and

hydrogenating the dendritic hydrocarbon polymer to produce the substantially saturated dendritic hydrocarbon polymer.

12. A process for making a substantially saturated dendritic hydrocarbon polymer, said process comprising:

hydrogenating one or more telechelic hydrocarbon polymers to produce substantially saturated one or more telechelic hydrocarbon polymers; and

reacting an amount of the substantially saturated one or more telechelic hydrocarbon polymers with an amount of one or more multifunctional coupling agents under conditions sufficient to produce the substantially saturated dendritic hydrocarbon polymer.

13. A process for making a substantially saturated dendritic hydrocarbon polymer, said process comprising:

polymerizing, by ring opening metathesis polymerization, an amount of one or more cyclic olefins with an amount of one or more bi-functional alkene chain terminating agents in the presence of a metathesis catalyst and under conditions sufficient to produce one or more telechelic hydrocarbon polymers;

hydrogenating the one or more telechelic hydrocarbon polymers to produce substantially saturated one or more telechelic hydrocarbon polymers; and

reacting an amount of the substantially saturated one or more telechelic hydrocarbon polymers with an amount of one or more multifunctional coupling agents under conditions sufficient to produce the substantially saturated dendritic hydrocarbon polymer.

14. The process of clauses 10-13 wherein the substantially saturated dendritic hydrocarbon polymer is a substantially saturated dendritic polyolefin.

15. A substantially saturated dendritic hydrocarbon polymer produced by the process of clauses 10-14.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims.

What is claimed is:

1. A process for making a dendritic hydrocarbon polymer, said process comprising:
reacting an amount of one or more telechelic hydrocarbon polymers with an amount of one or more multifunctional coupling agents under conditions sufficient to produce said dendritic hydrocarbon polymer.

2. The process of claim 1 wherein the dendritic hydrocarbon polymer is a dendritic polyolefin.

3. The process of claim 1 wherein the one or more telechelic hydrocarbon polymers are selected from hydroxyl-terminated poly(1,5-cyclooctadiene) (HO-PCOD), hydroxyl or carboxy-terminated polycyclooctene (HOOC-PCOE), bromo-terminated polycyclooctene (Br-PCOE), and hydroxyl-terminated polyethylene (HO-PE); and the one or more multifunctional coupling agents are selected from trifunctional silanes, polyols, polycarboxylic acids and tricarbonyl chlorides; wherein the trifunctional silanes are selected from trichloromethylsilane, trichloroethoxysilane, 1-dichloromethyl-2-chlorodimethyl-disiloxane, 1-dichloromethylsilyl-2-chlorodimethylsilyl ethane, and one or more compounds within the formula X₃Si(CH₂)ₙH and X₂(CH₃)₂Si—(CH₂)ₙ—Si(CH₃)₂X, wherein n is greater than or equal to 0, and X is a halogen or an alkoxy; the polyols are selected from glycerol, 1,2,6-hexanetriol, 1,3,5-benzenetriol, 1,1,1-tris(hydroxymethyl)propane, and pentaerythritol; and the polycarboxylic acids are selected from 1,2,4-benzenecarboxylic anhydride, 1,2,4-benzenecarboxylic acid, 1,3,5-benzenetricarboxylic acid, benzophenone-3,3′,4,4′-tetracarboxylic dianhydride, and trimesoyl chloride.

4. The process of claim 3 wherein the one or more telechelic hydrocarbon polymers and one or more trifunctional coupling agents are present in an equivalent concentration ratio (telechelic hydrocarbon polymer/trifunctional silane coupling agent) of from 1.7 to 3.0 equivalents.

5. A dendritic hydrocarbon polymer produced by the process of claim 1.

6. A process for making a dendritic hydrocarbon polymer, said process comprising:
polymerizing, by ring opening metathesis polymerization, an amount of one or more cyclic olefins with an amount of one or more bi-functional alkene chain terminating agents in the presence of a metathesis catalyst and under conditions sufficient to produce one or more telechelic hydrocarbon polymers; and
reacting an amount of the one or more telechelic hydrocarbon polymers with an amount of one or more multifunctional coupling agents under conditions sufficient to produce said dendritic hydrocarbon polymer.

7. The process of claim 6 wherein the dendritic hydrocarbon polymer is a dendritic polyolefin.

8. The process of claim 6 wherein the one or more cyclic olefins are selected from cyclooctene, 1,5-cyclooctadiene, 1,5-dimethylcyclooctadiene, norbornene, cyclopentene, and 1,5,9-cyclododecatriene; and the one or more bi-functional alkenes are selected from 1,4-diacetoxy-2-butene, 1,4-dibromo-2-butene, 1,4-dichloro-2-butene, maleic acid, and 9-octadecene-1,18-diol.

9. The process of claim 6 wherein the one or more cyclic olefins and one or more bi-functional alkenes are present in a molar concentration ratio (cyclic olefin/bi-functional alkene) of from 5 to 2500.

10. The process of claim 6 wherein the metathesis catalyst is a Grubbs 2^{nd} generation catalyst.

11. The process of claim 6 wherein the one or more telechelic hydrocarbon polymers are selected from hydroxyl-terminated poly(1,5-cyclooctadiene) (HO-PCOD), hydroxyl or carboxy-terminated polycyclooctene (HOOC-PCOE), bromo-terminated polycyclooctene (Br-PCOE), and hydroxyl-terminated polyethylene (HO-PE); and the one or more multifunctional coupling agents are selected from trifunctional silanes, polyols, polycarboxylic acids and tricarbonyl chlorides; wherein the trifunctional silanes are selected from trichloromethylsilane, trichioroethoxysilane, 1-dichloromethyl-2-chlorodimethyl-disiloxane, 1-dichloromethylsilyl-2-chlorodimethylsilyl ethane, and one or more compounds within the formula X₃Si(CH₂)ₙH and X₂(CH₃)₂Si—(CH₂)ₙ—Si(CH₃)₂X, wherein n is greater than or equal to 0, and X is a halogen or an alkoxy; the polyols are selected from glycerol, 1,2,6-hexanetriol, 1,3,5-benzenetriol, 1,1,1-tris(hydroxymethyl)propane, and pentaerythritol; and the polycarboxylic acids are selected from 1,2,4-benzenecarboxylic anhydride, 1,2,4-benzenecarboxylic acid, 1,3,5-benzenetricarboxylic acid, benzophenone-3,3′,4,4′-tetracarboxylic dianhydride, and trimesoyl chloride.

12. A dendritic hydrocarbon polymer produced by the process of claim 6.

13. A process for making a substantially saturated dendritic hydrocarbon polymer, said process comprising:
reacting an amount of one or more telechelic hydrocarbon polymers with an amount of one or more multifunctional coupling agents under conditions sufficient to produce a dendritic hydrocarbon polymer; and
hydrogenating the dendritic hydrocarbon polymer to produce the substantially saturated dendritic hydrocarbon polymer.

14. A substantially saturated dendritic hydrocarbon polymer produced by the process of claim 13.

15. A process for making a substantially saturated dendritic hydrocarbon polymer, said process comprising:
polymerizing, by ring opening metathesis polymerization, an amount of one or more cyclic olefins with an amount of one or more bi-functional alkene chain terminating agents in the presence of a metathesis catalyst and under conditions sufficient to produce one or more telechelic hydrocarbon polymers;
reacting an amount of the one or more telechelic hydrocarbon polymers with an amount of one or more multifunctional coupling agents under conditions sufficient to produce a dendritic hydrocarbon polymer; and
hydrogenating the dendritic hydrocarbon polymer to produce the substantially saturated dendritic hydrocarbon polymer.

16. A substantially saturated dendritic hydrocarbon polymer produced by the process of claim 15.

17. A process for making a substantially saturated dendritic hydrocarbon polymer, said process comprising:
hydrogenating one or more telechelic hydrocarbon polymers to produce substantially saturated one or more telechelic hydrocarbon polymers; and
reacting an amount of the substantially saturated one or more telechelic hydrocarbon polymers with an amount of one or more multifunctional coupling agents under conditions sufficient to produce the substantially saturated dendritic hydrocarbon polymer.

18. A substantially saturated dendritic hydrocarbon polymer produced by the process of claim 17.

19. A process for making a substantially saturated dendritic hydrocarbon polymer, said process comprising:
polymerizing, by ring opening metathesis polymerization, an amount of one or more cyclic olefins with an amount of one or more bi-functional alkene chain terminating agents in the presence of a metathesis catalyst and under conditions sufficient to produce one or more telechelic hydrocarbon polymers;
hydrogenating the one or more telechelic hydrocarbon polymers to produce substantially saturated one or more telechelic hydrocarbon polymers; and
reacting an amount of the substantially saturated one or more telechelic hydrocarbon polymers with an amount of one or more multifunctional coupling agents under conditions sufficient to produce the substantially saturated dendritic hydrocarbon polymer.

20. A substantially saturated dendritic hydrocarbon polymer produced by the process of claim 19.
